(19) United States
(12) Patent Application Publication
(10) Pub. No.: US 2024/0057216 A1
(43) Pub. Date: Feb. 15, 2024

(54) MANAGING CONDITIONAL CONFIGURATION IN SCG DEACTIVATION SCENARIOS

(71) Applicant: GOOGLE LLC, Mountain View, CA (US)

(72) Inventor: Chih-Hsiang Wu, Taoyuan City (TW)

(21) Appl. No.: 18/268,213

(22) PCT Filed: Dec. 10, 2021
(86) PCT No.: PCT/US21/62798

§ 371 Date: Jun. 16, 2023

Related U.S. Application Data
(60) Provisional application No. 63/126,161, filed on Dec. 16, 2020.

(51) Int. Cl. H04W 76/34; H04W 36/00; H04W 36/36

(52) U.S. Cl. CPC H04W 76/34; H04W 36/0069; H04W 36/362

(57) ABSTRACT

A UE, communicating in dual connectivity (DC) with a radio access network (RAN) via a master node (MN) and a secondary node (SN), can implement a method for managing a conditional configuration during deactivation of a secondary cell group (SCG). The method can be implemented by processing hardware and includes receiving (1102), from the RAN, the conditional configuration related to a DC procedure and a condition to be satisfied before the UE applies the conditional configuration. The method also includes deactivating (1104) the SCG at the UE and processing (1106) the conditional configuration in view of the deactivating, including by preventing the UE from applying the conditional configuration.

### TECHNICAL FIELD

This disclosure relates generally to wireless communications and, more particularly, to managing a conditional configuration associated to a user equipment in dual connectivity with a master node and a secondary node while the UE and SN deactivate a secondary cell group.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, the UE and a base station can use SRBs to exchange RRC messages as well as non-access stratum (NAS) messages, and can use DRBs to transport data on a user plane.

UEs can use several types of SRBs and DRBs. When operating in dual connectivity (DC), the cells associated with the base station operating as the master node (MN) define a master cell group (MCG), and the cells associated with the base station operating as the secondary node (SN) define the secondary cell group (SCG). So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. MCG DRBs use the lower-layer resources of only the MN, SCG DRBs use the lower-layer resources of only the SN, and split DRBs use the lower-layer resources of both the MCG and the SCG. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

As noted above, a UE in some scenarios can operate in DC by concurrently utilizing resources of multiple RAN nodes (e.g., multiple base stations or components of a distributed base station), which are interconnected by a backhaul. When these RAN nodes support different radio access technologies (RATs), this type of connectivity is referred to as Multi-Radio Dual Connectivity (MR-DC). When a UE operates in MR-DC, one base station operates as an MN that covers a primary cell (PCell), and the other base station operates as a secondary node (SN) that covers a primary secondary cell (PSCell). The UE communicates with the MN via the PCell, and with the SN via the PSCell. In other scenarios, the UE utilizes resources of only one base station at a time. One base station and/or the UE may then determine that the UE should establish a radio connection with another base station. For example, one base station can determine to hand the UE over to the second base station, and initiate a handover procedure.

The 3GPP specifications TS 36.300 and TS 38.300 describe procedures for handover (also called “reconfiguration with sync”) scenarios. These procedures involve messaging (e.g., RRC signaling and preparation) between RAN nodes that generally causes latency, which in turn increases the probability of failure for handover procedures. Some handover procedures do not involve triggering conditions associated with the UE, and can be referred to as “immediate” handover procedures.

3GPP specification TS 37.340 v15.7.0 describes procedures for a UE to add or change an SN in DC scenarios. These procedures involve messaging (e.g., RRC signaling and preparation) between RAN nodes. This messaging generally causes latency, which in turn increases the probability that the SN addition or SN change procedure will fail. These procedures, which do not involve triggering conditions that are checked at the UE, can be referred to as “immediate” SN addition and SN change procedures.

UEs can also perform handover procedures to switch from one cell to another, whether in single connectivity (SC) or DC operation. The UE may handover from a cell of a first base station to a cell of a second base station, or from a cell of a first distributed unit (DU) of a base station to a cell of a second DU of the same base station, depending on the scenario. 3GPP specifications 38.401 v15.6.0, 36.300 v15.6.0 and 38.300 v15.6.0 describe a handover procedure that includes several steps (RRC signaling and preparation) between RAN nodes, which causes latency in the handover procedure and therefore increases the risk of handover failure. This procedure, which does not involve triggering conditions that are checked at the UE, can be referred to as an “immediate” handover procedure.

More recently, for handover, SN addition/change, or PSCell addition/change, “conditional” procedures have been considered (i.e., conditional handover, conditional SN addition/change, or conditional PSCell addition/change). For example, scenarios involving conditional handover procedures are described in 3GPP specifications 36.300 and 38.300 v16.3.0. Unlike the “immediate” mobility procedures discussed above, these conditional mobility procedures do not perform the handover, or add or change the SN or PSCell, until the UE determines that a condition is satisfied. As used herein, the term “condition” may refer to a single, detectable state or event (e.g., a particular signal quality metric exceeding a threshold), or to a logical combination of such states or events (e.g., “Condition A and Condition B,” or “(Condition A or Condition B) and Condition C”, etc.).

To configure a conditional procedure, the RAN provides the condition to the UE, along with a configuration (e.g., one or more random-access preambles, etc.) that will enable the UE to communicate with the appropriate base station, or via the appropriate cell, when the condition is satisfied. For a conditional addition of a base station as an SN or a candidate cell as a PSCell, for example, the RAN provides the UE with a condition to be satisfied before the UE can add that base station as the SN or that candidate cell as the PSCell, and a configuration that enables the UE to communicate with that base station or PSCell after the condition has been satisfied. The configuration associated with the condition is at times referred to herein as the “conditional configuration” or “conditional reconfiguration.” 3GPP specifications 36.331 and 38.331 v16.3.0 describe a data structure a base station can use to indicate a conditional (re)configuration, and a condition to be satisfied prior to applying the conditional configuration, respectively.

Operating in DC with the MN and the SN places high power demands on the UE. Further, the amount of data that the UE has to exchange with the SN varies with time. For example, at a first time, the UE may not have data to exchange with the SN. As a result, the UE may be consuming large amounts of power to support a link with the SN that the UE is not actively using. However, a short time later, the UE may have data to exchange with the SN. Thus, it may be inefficient for the RAN to release the SN while there is low data activity for the UE, even in scenarios where the UE would benefit from the power savings.

One way to address this inefficiency is for the UE and the RAN to deactivate the SCG, causing the SN and the UE to suspend communications over the SCG. However, it is not clear how the UE is to handle a conditional configuration for a conditional SN or PSCell after deactivating the SCG.

### SUMMARY

Accordingly, a UE and/or a RAN implement the techniques of this disclosure to manage conditional configurations during deactivation of an SCG. When the SCG is deactivated, the SN and the UE suspend communications over the SCG. Depending on the implementation, the UE, the MN, or the SN may determine to deactivate and/or reactivate the SCG.

Prior to deactivating the SCG, the UE may receive a conditional configuration related to a DC procedure (e.g., a conditional SN addition or change (CSAC) procedure or a conditional PSCell change (CPC) procedure). The conditional configuration includes a condition to be satisfied before the UE applies the conditional configuration. The UE can start to monitor for the condition before the SCG is deactivated. After the SCG is deactivated, the UE can process the conditional configuration using the techniques described below.

In some embodiments, the UE releases the conditional configuration after deactivating the SCG. In some implementations, the UE releases the conditional configuration based on the deactivation of the SCG and without receiving a request from the RAN. In other implementations, the UE initially retains the conditional configuration, but receives a message from the RAN instructing the UE to release or update the conditional configuration. The update to the conditional configuration may prevent the UE from applying the conditional configuration. For example, the RAN can change the condition to a condition that is unlikely to be satisfied, or can change the candidate cell to which the conditional configuration pertains to a cell that is not near the geographic location of the UE.

In other embodiments, the UE retains the conditional configuration and continues to monitor whether the condition is satisfied while the SCG is deactivated. In some implementations, if the UE detects that the condition is satisfied, the UE applies the configuration (e.g., connects to the candidate SN (C-SN) in the case of a CSAC procedure, or connects to the candidate PSCell (C-PSCell) in the case of a CPC procedure). After applying the configuration, the UE can either reactivate the SCG or allow the SCG to remain deactivated. In other implementations, if the UE detects that the condition is satisfied and the SCG is deactivated, the UE prevents the UE from applying the conditional condition. If the SCG is later activated, the UE may apply the conditional configuration in response to detecting that the condition is satisfied.

In still other embodiments, the UE retains the conditional configuration, but stops monitoring whether the condition is satisfied. If the SCG is later activated, then the UE may restart monitoring for the condition.

One example embodiment of these techniques is a method in a user equipment (UE), communicating in dual communicating in dual connectivity (DC) with a radio access network (RAN) via a master node (MN) and a secondary node (SN), for managing a conditional configuration during deactivation of a secondary cell group (SCG). The method can be implemented by processing hardware and includes receiving, from the RAN, the conditional configuration related to a DC procedure and a condition to be satisfied before the UE applies the conditional configuration. The method also includes deactivating the SCG at the UE and processing the conditional configuration in view of the deactivating.

Another example embodiment of these techniques is a UE including processing hardware and configured to implement the method above.

A further example embodiment of these techniques is a method in a RAN, communicating with a UE in DC, for managing a conditional configuration during deactivation of an SCG. The method can be implemented by processing hardware and includes providing, to the UE, the conditional configuration related to a DC procedure and a condition to be satisfied before the UE applies the conditional configuration. The method also includes deactivating the SCG at an SN of the RAN and releasing at least one of the condition or at least a portion of the conditional configuration in view of the deactivating.

Yet another example embodiment of these techniques is one or more network nodes of a RAN including processing hardware and configured to implement the method above.

### BRIEF DESCRIPTION OF THE DRAWINGS

FIG. 1A is a block diagram of an example system in which one or more base stations and/or a user equipment (UE) can implement the techniques of this disclosure for managing conditional configurations during SCG deactivation;

FIG. 1B is a block diagram of an example base station including a central unit (CU) and a distributed unit (DU) that can operate in the system of FIG. 1A;

FIG. 2 is a block diagram of an example protocol stack according to which the UE of FIG. 1A can communicate with base stations;

FIG. 3A is an example messaging diagram of an example scenario in which a master node (MN) causes a secondary node (SN) to deactivate an SCG for a UE;

FIGS. 3B-3C are example messaging diagrams of example scenarios in which an SN deactivates an SCG for a UE;

FIG. 3D is an example messaging diagram of an example scenario in which a UE causes an SN to deactivate an SCG for the UE;

FIG. 3E is an example messaging diagram of an example scenario in which an MN causes an SN to reactivate an SCG for a UE;

FIG. 3F is an example messaging diagram of an example scenario in which an SN reactivates an SCG for a UE;

FIG. 4A is an example messaging diagram of an example scenario in which a UE continues to monitor, after deactivating an SCG, whether a condition for applying a conditional configuration related to an PSCell change (CPC) procedure is satisfied, and, after detecting the condition and applying the conditional configuration, reactivates the SCG;

FIG. 4B is an example messaging diagram of an example scenario similar to the scenario of FIG. 4A, but where the UE does not reactivate the SCG after detecting the condition and applying the conditional configuration;

FIG. 4C is an example messaging diagram of an example scenario in which a UE, after deactivating an SCG, either (i) stops monitoring whether a condition for applying a conditional configuration related to a CPC procedure is satisfied, or (ii) refrains from applying the conditional configuration if the UE detects that the condition is satisfied;

FIG. 4D is an example messaging diagram of an example scenario in which a UE deactivates an SCG and releases a conditional configuration related to a CPC procedure automatically in response to deactivating the SCG or after receiving an indication from the RAN to release the conditional configuration;

FIG. 4E is an example messaging diagram of an example scenario in which a UE deactivates an SCG and updates a conditional configuration related to a CPC procedure after receiving an indication from the RAN to update the conditional configuration;

FIGS. 5A-5E are an example messaging diagrams of example scenarios similar to the scenarios of FIGS. 4A-4E, respectively, but where the conditional configuration is related to an SN addition or change (CSAC) procedure;

FIG. 6A is a flow diagram of an example method in which a UE reactivates a cell group (CG) in response to or after detecting that a condition related to a conditional configuration is satisfied;

FIG. 6B is a flow diagram of an example method similar to the method of FIG. 6A, but where the UE does not reactivate the CG;

FIG. 7A is a flow diagram of an example method in which a UE receives a conditional configuration for a candidate cell of a CG and determines whether to monitor for the condition based on whether the CG is deactivated;

FIG. 7B is a flow diagram of an example method in which a UE receives a conditional configuration for a candidate cell of a CG, detects the condition, and determines whether to connect to the candidate cell based on whether the CG is deactivated;

FIG. 8 is a flow diagram of an example method in which a UE deactivates an SCG and releases a conditional configuration in response to receiving an SCG command from a RAN;

FIG. 9A is a flow diagram of an example method in which a RAN reactivates a CG in response to or after determining that the UE applied a conditional configuration for a candidate cell of the CG;

FIG. 9B is a flow diagram of an example method similar to the method of FIG. 9A, but where the RAN does not reactivate the CG;

FIG. 10 is a flow diagram of an example method in which a RAN sends the UE a message to update or release a conditional configuration for a secondary cell in response to determining to deactivate the SCG;

FIG. 11 is a flow diagram of an example method for managing a conditional configuration during SCG deactivation, which can be implemented by a UE; and

FIG. 12 is a flow diagram of an example method for managing a conditional configuration during SCG deactivation, which can be implemented by a RAN.

### DETAILED DESCRIPTION OF THE DRAWINGS

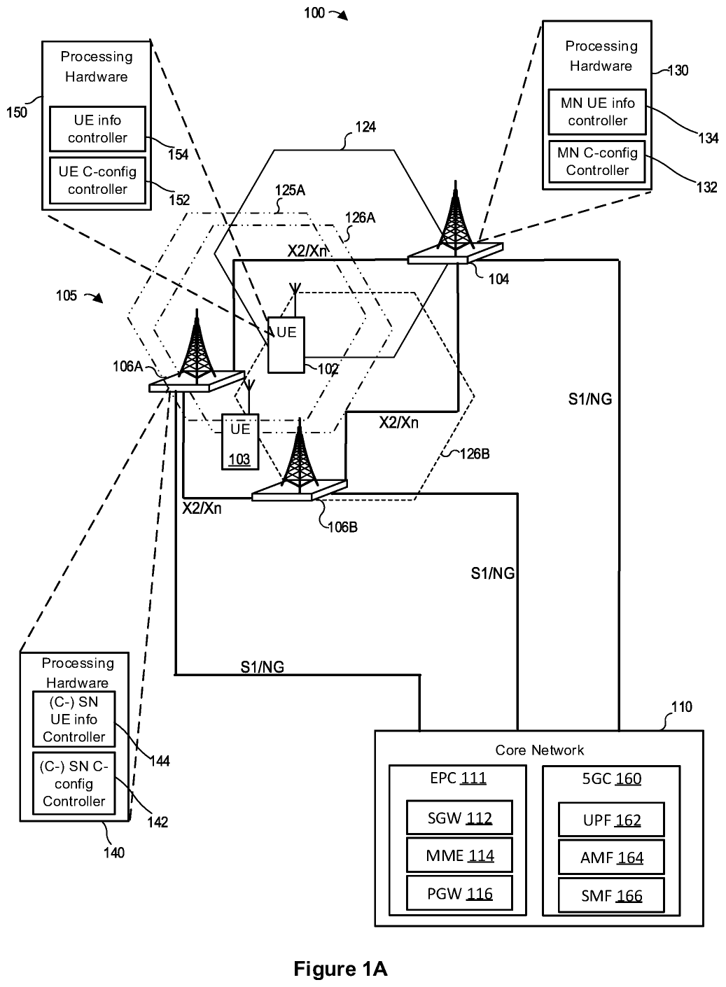

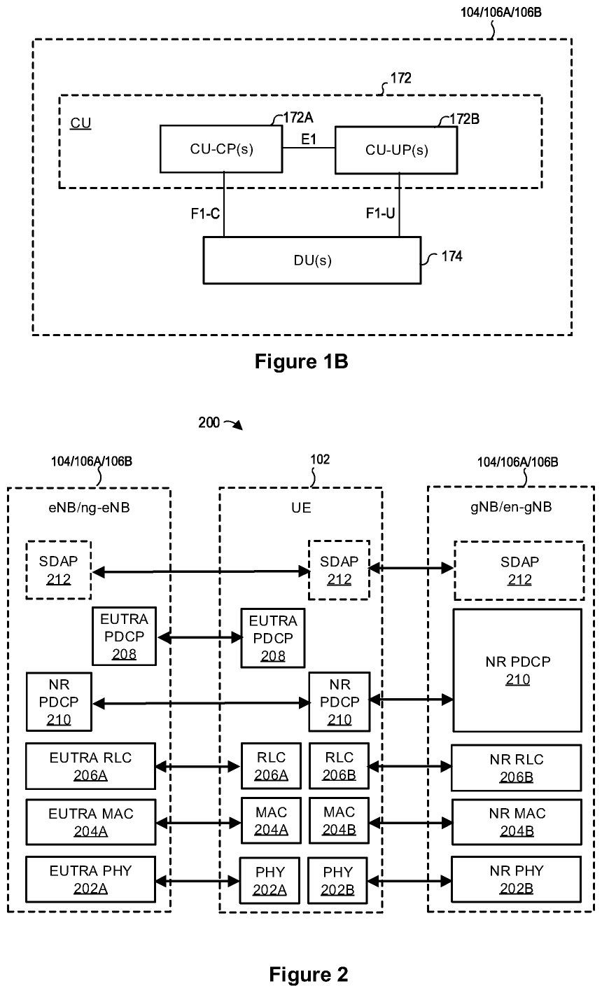

FIG. 1A depicts an example wireless communication system 100 in which a UE and/or a base station can implement the techniques of this disclosure. The wireless communication system 100 includes UEs 102 and 103, as well as base stations 104, 106A, 106B that operate in a radio access network (RAN) 105 and are connected to a core network (CN) 110. The base stations 104, 106A, 106B can be any suitable type, or types, of base stations, such as an evolved node B (eNB), a next-generation eNB (ng-eNB), or a 5G Node B (gNB), for example. As a more specific example, the base station 104 may be an eNB or a gNB, and the base stations 106A, 106B may be gNBs.

The base station 104 supports a cell 124, the base station 106A supports a cell 126A, and the base station 106B supports a cell 126B. The base station 106A can additionally support a cell 125A. The cell 124 partially overlaps both of cells 126A and 126B, so that the UE 102 can be in range to communicate with the base station 106A while simultaneously being in range to communicate with the base station 106A and/or 106B (or in range to detect or measure the signal from both base stations 104 and 106A, etc.). The overlap may make it possible for the UE 102 to hand over between cells (e.g., from cell 124 to cell 126A or 126B) before the UE 102 experiences radio link failure, for example. The base station 106A can additionally support a cell 125A which can overlap the cell 124. Moreover, the overlap allows the various dual connectivity (DC) scenarios discussed below. For example, the UE 102 can communicate in DC with the base station 104 (operating as a master node (MN)) and the base station 106A (operating as an SN) and, upon completing an SN change, can communicate with the base station 104 (operating as an MN) and the base station 106B (operating as an SN). More particularly, when the UE 102 is in DC with the base station 104 and the base station 106A, the base station 104 operates as an MeNB, an Mng-eNB or an MgNB, and the base station 106A operates as an SgNB or an Sng-eNB.

In some implementations and scenarios where the UE 102 is in single connectivity (SC) with the base station 104 but is capable of operating in DC, the base station 104 operates as an MeNB, an Mng-eNB or an MgNB, and the base station 106A operates as a candidate SgNB (C-SgNB) or a candidate Sng-eNB (C-Sng-eNB).

In scenarios where the UE 102 hands over from the base station 104 to the base station 106B, the base stations 104 and 106B operate as the source base station (S-BS) and a target base station (T-BS), respectively. The UE 102 may operate in DC with the base station 104 and the base station 106A prior to the handover, and continue to operate in DC with the base station 104 and the base station 106A after completing the handover. As used herein, the term “MN” can be used to refer to a base station operating as an MN for a UE in DC operation, or as a base station serving the UE in SC operation. Thus, the base stations 104 and 106B in this case can be said to operate as a source MN (S-MN) and a target MN (T-MN), respectively, if the handover is immediate. When the handover is conditional, however, the base station 106B operates as a “conditional” or “candidate” T-MN, which may be referred to herein as “C-T-MN” or simply “C-MN.”

Although various scenarios are described below in which the base station 104 operates as an MN and the base station 106A (or 106B) operates as an SN or C-SN, any of the base stations 104, 106A, 106B generally can operate as an MN, an SN or a C-SN in different scenarios. Thus, in some implementations, the base station 104, the base station 106A, and the base station 106B can implement similar sets of functions and each support MN, SN and C-SN operations.

In operation, the UE 102 can use a radio bearer (e.g., a data radio bearer (DRB) or a signal radio bearer (SRB)) that at different times terminates at an MN (e.g., the base station 104) or an SN (e.g., the base station 106A). The UE 102 can apply one or more security keys when communicating on the radio bearer, in the uplink (from the UE 102 to a base station) and/or downlink (from a base station to the UE 102) direction.

The base station 104 includes processing hardware 130, which may include one or more general-purpose processors (e.g., central processing units (CPUs)) and a computer-readable memory storing machine-readable instructions executable on the general-purpose processor(s), and/or special-purpose processing units. The processing hardware 130 in the example implementation of FIG. 1A includes a configuration controller 132 that is configured to manage or control configuration techniques in support of immediate and conditional mobility procedures. For example, the configuration controller 132 may support radio resource control (RRC) messaging associated with immediate and conditional handover procedures, and/or support RRC messaging associated with immediate and conditional addition/change operations when the base station 104 operates as an MN relative to an SN. Moreover, in some implementations and/or scenarios, the configuration controller 132 may be responsible for maintaining (for the UE 102 and a number of other UEs) current sets of conditional configurations for conditional mobility procedures. The processing hardware 130 in the example implementation of FIG. 1A also includes a UE information controller 134 that is configured to manage or control the techniques of this disclosure relating to management of UE information. For example, the UE information controller 134 may support RRC messaging associated with UE information procedures, and/or support operations that the base station 104 performs based on UE information when the base station 104 operates as an MN relative to an SN. “UE information” broadly refers to information that a UE provides to a base station of a RAN while the UE is in a connected state with the base station, with the UE information indicating preferences and/or circumstances of the UE (e.g., a configuration preferred by a UE, coexisting communication systems that a UE is using, desires to use, or may use, etc.). Some specific examples of UE information are discussed below.

The base station 106A includes processing hardware 140, which may include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a configuration controller 142 that is configured to manage or control RRC procedures and RRC configurations. For example, the configuration controller 142 may support RRC messaging associated with immediate and conditional handover procedures, and/or support RRC messaging associated with immediate and conditional addition/change operations when the base station 106A operates as an SN or candidate SN (C-SN). Moreover, in some implementations and/or scenarios, the configuration controller 142 may be responsible for maintaining (for the UE 102 and a number of other UEs) current sets of conditional configurations for conditional mobility procedures. The processing hardware 140 in the example implementation of FIG. 1A includes a UE information controller 144 that is configured to manage or control the techniques of this disclosure relating to management of UE information. For example, the UE information controller 144 may support RRC messaging associated with UE information procedures, and/or support operations that the base station 106A performs based on UE information when the base station 106A operates as an SN or candidate SN (C-SN). While not shown in FIG. 1A, the base station 106B may include processing hardware similar to the processing hardware 140 of the base station 106A. Moreover, while this disclosure describes different operations for the base stations 104, 106A, 106B to reflect their different, scenario-specific operations (e.g., when the base station 104 is an MN, the base station 106A is a C-SN, and the base station 106B is an SN), the processing hardware of the base stations 104, 106A, 106B may all include controllers with similar capabilities/functionality.

The UE 102 includes processing hardware 150, which may include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a configuration controller 152 that is configured to manage or control RRC procedures and RRC configurations related to configurations for mobility procedures, including conditional mobility procedures. For example, the configuration controller 152 may support RRC messaging associated with immediate and conditional handover and/or secondary node addition/change procedures, and may also be responsible for maintaining a current set of conditional configurations for the UE 102 (e.g., adding, releasing, or modifying conditional configurations as needed) in accordance with any of the implementations discussed below. The processing hardware 150 in the example implementation of FIG. 1A also includes a UE information controller 154 that is configured to manage or control the UE information techniques of this disclosure. For example, the UE information controller 144 may support RRC messaging associated with the UE information procedures discussed herein.

The CN 110 may be an evolved packet core (EPC) 111 or a fifth-generation core (5GC) 160, both of which are depicted in FIG. 1A. Each of the base stations 104, 106B may be an eNB supporting an S1 interface for communicating with the EPC 111, an ng-eNB supporting an NG interface for communicating with the 5GC 160, or a gNB that supports the NR radio interface as well as an NG interface for communicating with the 5GC 160, as shown in FIG. 1A. The base station 106A may be an EUTRA-NR DC (EN-DC) gNB (en-gNB) with an S1 interface to the EPC 111, an en-gNB that does not connect to the EPC 111, a gNB that supports the NR radio interface as well as an NG interface to the 5GC 160, or an ng-eNB that supports an EUTRA radio interface as well as an NG interface to the 5GC 160. To directly exchange messages with each other during the various scenarios discussed below, the base stations 104, 106A, 106B may support an X2 or Xn interface, as shown in FIG. 1A.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is generally configured to manage authentication, registration, paging, and other related functions. The PGW 116 is generally configured to provide connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or a Session Management Function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

Generally, the wireless communication system 100 may include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and specific radio access technology (RAT) types (5G NR and EUTRA), in general the techniques of this disclosure can also apply to other suitable radio access and/or core network technologies, such as sixth generation (6G) radio access, and/or 6G core network or 5G NR-6G DC, for example.

As indicated above, the wireless communication system 100 may support various mobility procedures (e.g., immediate or conditional handover, SN addition, etc.) and modes of operation (e.g., SC or DC). Example operation of various procedures that may be implemented in the wireless communication system 100 will now be described.

In some implementations, the wireless communication system 100 supports immediate handovers between cells. In one scenario, for example, the UE 102 initially connects to the base station 104, and the base station 104 later performs preparation for an immediate handover with the base station 106A via an interface (e.g., X2 or Xn). In this scenario, the base stations 104 and 106A operate as a source base station and a target base station, respectively. In the handover preparation, the source base station 104 sends a Handover Request message to the target base station 106A. In response, the target base station 106A includes an immediate handover command message in a Handover Request Acknowledge message, and sends the Handover Request Acknowledge message to the source base station 104. The source base station 104 then transmits a handover command message to the UE 102 in response to receiving the Handover Request Acknowledge message.

Upon receiving the immediate handover command message, the UE 102 immediately reacts to the immediate handover command, by attempting to connect to the target base station 106A. To connect to the target base station 106A, the UE 102 may perform a random access procedure with the target base station 106A, and then (after gaining access to a channel) transmit a handover complete message to the target base station 106A via a cell (e.g., cell 126A) of the base station 106A (i.e., in response to the immediate handover command).

In some implementations, the wireless communication system 100 also supports conditional handovers. In one scenario, for example, the UE 102 initially connects to the base station 104, and the base station 104 later performs a first conditional handover preparation procedure with the base station 106A via an interface (e.g., X2 or Xn) to prepare for a potential handover of the UE 102 to the base station 106A. In this scenario, the base stations 104 and 106A operate a source base station and a candidate base station, respectively. In the first conditional handover preparation procedure, the source base station 104 sends a Handover Request message to the candidate base station 106A. In response, the candidate base station 106A includes a first conditional handover command message in a Handover Request Acknowledge message, and sends the Handover Request Acknowledge message to the source base station 104. The source base station 104 then transmits the first conditional handover command message to the UE 102, in response to receiving the Handover Request Acknowledge message.

Upon receiving the first conditional handover command message, the UE 102 does not immediately react to the message by attempting to connect to the candidate base station 106A. Instead, the UE 102 connects to the candidate base station 106A according to the first conditional handover command message only if the UE 102 determines that a first condition is satisfied for handing over to a candidate cell 126A of the candidate base station 106A. The base station 106A provides a configuration for the candidate cell 126A (i.e., a configuration that the UE 102 can use to connect with the base station 106A via the candidate cell 126A) in the first conditional handover command message.

Before the first condition is met, the UE 102 has not yet connected to the candidate base station 106A. In other words, the candidate base station 106A has not yet connected and served the UE 102. In some implementations, the first condition can be that a signal strength/quality, as measured by the UE 102 on the candidate cell 126A of the candidate base station 106A, is “good” enough, and/or a signal strength/quality, as measured by the UE 102 on the cell 124 of the source base station 104, is poor. For example, the first condition may be satisfied if one or more measurement results obtained by the UE 102 (when performing measurements on the candidate cell 126A) exceed a threshold that is configured by the source base station 104, which could be a pre-determined or pre-configured threshold, and/or if one or more measurement results obtained by the UE 102 (when performing measurements on the candidate cell 124) exceed a threshold that is configured by the source base station 104, which could be a pre-determined or pre-configured threshold. In some implementations, the first condition can be that a signal strength/quality, as measured by the UE 102 on the candidate cell 126A is better than a signal strength/quality, as measured by the UE 102 on the cell 124, by at least some threshold value (e.g., at least an offset). The threshold value can be configured by the source base station 104 or a pre-determined or pre-configured offset. If the UE 102 determines that the first condition is satisfied, the candidate base station 106A becomes the target base station 106A for the UE 102, and the UE 102 attempts to connect to the target base station 106A. To connect to the target base station 106A, the UE 102 may perform a random access procedure with the target base station 106A, and then (after gaining access to a channel) transmit a first handover complete message via the candidate cell 126A to the target base station 106A. After the UE 102 successfully completes the random access procedure and/or transmits the first handover complete message, the target base station 106A becomes the source base station 106A for the UE 102, and the UE 102 starts communicating data with the source base station 106A.

In some implementations and/or scenarios, conditional handovers can occur with more than one candidate cell supported by the candidate base station 106A (e.g., cell 126A and another cell of base station 106A not shown in FIG. 1A). In one such scenario, the base station 106A may provide a configuration of an additional candidate cell of the base station 106A, in addition to a configuration of the candidate cell 126A, in the first conditional handover command message. The UE 102 may then monitor whether a second condition is met for the additional candidate cell of the candidate base station 106A, while also monitoring whether the first condition is met for the candidate cell 126A. The second condition can be the same as or different from the first condition.

In another scenario, the base station 104 performs a second conditional handover preparation procedure with the base station 106A via the interface (e.g., X2 or Xn), to prepare a potential handover of the UE 102 to the base station 106A, in a procedure similar to that described above. In this scenario, however, the base station 104 also transmits to the UE 102 a second conditional handover command message that the base station 104 received from the candidate base station 106A, for a potential handover to an additional candidate cell (not shown in FIG. 1A) of the base station 106A. The base station 106A may provide a configuration of the additional candidate cell in the second conditional handover command message. The UE 102 may then monitor whether a second condition is met for the additional candidate cell of the candidate base station 106A. The second condition can be the same as or different from the first condition.

The base station 104 may also perform a third conditional handover preparation procedure with the base station 106B via an interface (e.g., X2 or Xn), to prepare a potential handover of the UE 102 to the base station 106B, in a procedure similar to that described above. For example, in this scenario, the base station 104 may transmit to the UE 102 a third conditional handover command message, which the base station 104 received from the candidate base station 106B for a potential handover to the cell 126B the candidate base station 106B. The base station 106B may provide a configuration of the candidate cell 126B in the third handover command message. The UE 102 may then monitor whether a third condition is met for the candidate cell 126B. The third condition can be the same as or different from the first and/or second conditions. The conditional handover command messages above may be RRC reconfiguration messages, or may be conditional handover configurations that are information elements (IEs).

In some implementations, the wireless communication system 100 supports DC operation, including SN addition and SN change procedures. In one scenario, for example, after the UE 102 connects to the base station 104, the base station 104 can perform an immediate SN addition procedure to add the base station 106A as a secondary node, thereby configuring the UE 102 to operate in DC with the base stations 104 and 106A. At this point, the base stations 104 and 106A operate as an MN and an SN, respectively. Later, while the UE 102 is still in DC with the MN 104 and the SN 106A, the MN 104 may perform an immediate SN change procedure to change the SN of the UE 102 from the base station 106A (which may be referred to as the source SN or S-SN) to the base station 106B (which may be referred to as the target SN or T-SN).

In other scenarios, the base station 104 may perform a conditional SN addition procedure to configure the base station 106B as a candidate SN (C-SN) for the UE 102, while the UE 102 is in single connectivity (SC) with the base station 104, or while the UE 102 is in DC with the base stations 104 and 106A, and before the UE 102 has connected to the C-SN 106B. In this case, the base stations 104 and 106B operate as an MN and a C-SN, respectively, for the UE 102. When the UE 102 receives the configuration for the C-SN 106B, the UE 102 does not connect to the C-SN 106B unless and until the UE 102 detects that the corresponding condition is satisfied. If the UE 102 determines that the condition is satisfied, the UE 102 connects to the C-SN 106B, such that the C-SN 106B becomes the SN 106B for the UE 102.

In some implementations, the condition can be that a signal strength/quality, as measured by the UE 102 on a candidate primary secondary cell (C-PSCell) of the C-SN 106B (e.g., cell 126B), is “good” enough, and/or a signal strength/quality, as measured by the UE 102 on a PSCell 126A of the SN 106A, is poor (if the UE 102 is DC with the MN 104 and the SN 106A). For example, the condition may be satisfied if one or more measurement results obtained by the UE 102 (when performing measurements on the C-PSCell) exceed a threshold that is configured by the MN 104, or above a pre-determined or pre-configured threshold, and/or if one or more measurement results obtained by the UE 102 (when performing measurements on the C-PSCell 126A) exceed a threshold that is configured by the MN 104 or SN 106A, which can be a pre-determined or pre-configured threshold. In other implementations, if the UE 102 is in DC with the MN 104 and the SN 106A, the condition can be that a signal strength/quality, as measured by the UE 102 on the C-PSCell 126B is exceeds a signal strength/quality, as measured by the UE 102 on the PSCell 126A, by at least some threshold value (e.g., at least some offset). The threshold can be configured by the MN 104 or SN 106A, or can be a pre-determined or pre-configured offset, for example. If the UE 102 determines that condition is satisfied, the UE 102 may perform a random access procedure with the C-SN 106B to connect to the C-SN 106B. After the UE 102 successfully completes the random access procedure, the base station 106B becomes an SN for the UE 102, and the C-PSCell (e.g., cell 126B) becomes a PSCell for the UE 102. The SN 106B may then start communicating data with the UE 102.

Yet another scenario relates to a conditional PSCell change. In this scenario, the UE 102 is initially in DC with the MN 104 (via a primary cell (PCell)) and the SN 106A (via a PSCell, not shown in FIG. 1A, that is different than cell 126A). The SN 106A can provide a configuration for the C-PSCell 126A, for the UE 102. If the UE 102 is configured with an SRB that permits the exchange of RRC messages with the SN 106A (e.g., SRB3), the SN 106A may transmit the configuration for the C-PSCell 126A to the UE 102 directly via the SRB, or via the MN 104. In some implementations, the SN 106A may transmit an RRC reconfiguration message including the configuration via the SRB to the UE 102. If the UE 102 has not been configured with the SRB, or if the SN 106A determines to transmit the configuration via the MN 104, the SN 106A may transmit the configuration for the C-PSCell 126A to the UE 102 via the MN 104. In some implementations, the SN 106A may send the RRC reconfiguration message to the MN 104 and in turn, the MN 104 transmits the RRC reconfiguration message to the UE 102. The SN 106A may transmit the configuration in response to one or more measurement results received from the UE 102 via the SRB, or in response to one or more measurement results obtained by the SN 106A from measurements on signals received from the UE 102, for example.

In contrast to the immediate PSCell change case discussed above, in a conditional procedure, the UE 102 does not immediately disconnect from the PSCell and attempt to connect to the C-PSCell 126A after receiving the configuration for the C-PSCell 126A. Instead, the UE 102 does not connect to the C-PSCell 126A until the UE 102 determines that a certain condition is satisfied. When the UE 102 determines that the condition has been satisfied, the UE 102 connects to the C-PSCell 126A, such that the C-PSCell 126A begins to operate as the PSCell 126A for the UE 102. In some implementations, the UE 102 disconnects from the current PSCell in order to connect to the C-PSCell 126A.

In some scenarios, the condition associated with conditional SN addition or conditional PSCell change can be that signal strength/quality, as measured by the UE 102 on the C-PSCell 126A of the (C-)SN 106A, exceeds a certain threshold or otherwise corresponds to an acceptable measurement, and/or a signal strength/quality, as measured by the UE 102 on the current PSCell of the SN 106A, is poor. For example, when the one or more measurement results that the UE 102 obtains on the C-PSCell 126A are above a threshold configured by the MN 104 or the (C-)SN 106A, or above a pre-determined or pre-configured threshold, the UE 102 may determine that the condition is satisfied. In other implementations, if the UE 102 is in DC with the MN 104 and the SN 106A, the condition can be that a signal strength/quality, as measured by the UE 102 on the C-PSCell 126A exceeds a signal strength/quality, as measured by the UE 102 on the current PSCell, by at least some threshold value (e.g., at least some offset). The threshold value can be configured by the SN 106A, or a pre-determined or pre-configured offset, for example. When the UE 102 determines that such a condition is satisfied, the UE 102 can perform a random access procedure on the C-PSCell 126A and with the C-SN 106A to connect to the C-SN 106A. After the UE 102 successfully completes the random access procedure on the C-PSCell 126A, the C-PSCell 126A becomes a PSCell 126A for the UE 102. The C-SN 106A can then start communicating data (user-plane data and/or control-plane data) with the UE 102 through the PSCell 126A.

In different implementations and/or scenarios of the wireless communication system 100, the base station 104 may operate as a master eNB (MeNB) or a master gNB (MgNB), and the base station 106A or 106B can be implemented as a secondary gNB (SgNB) or a candidate SgNB (C-SgNB). The UE 102 may communicate with the base station 104 and the base station 106A or 106B via the same RAT, such as EUTRA or NR, or via different RATs. If the base station 104 is an MeNB and the base station 106A is an SgNB, the UE 102 may be in EN-DC with the MeNB and the SgNB. In this scenario, the MeNB 104 may or may not configure the base station 106B as a C-SgNB to the UE 102. When the base station 104 is an MeNB and the base station 106A is a C-SgNB for the UE 102, the UE 102 may be in SC with the MeNB. In this scenario, the MeNB 104 may or may not configure the base station 106B as another C-SgNB to the UE 102.

In some cases, an MeNB, an SeNB or a C-SgNB may be implemented as an ng-eNB rather than an eNB. When the base station 104 is a master ng-eNB (Mng-eNB) and the base station 106A is a SgNB, the UE 102 may be in next generation (NG) EUTRA-NR DC (NGEN-DC) with the Mng-eNB and the SgNB. In this scenario, the MeNB 104 may or may not configure the base station 106B as a C-SgNB to the UE 102. When the base station 104 is an Mng-NB and the base station 106A is a C-SgNB for the UE 102, the UE 102 may be in SC with the Mng-NB. In this scenario, the Mng-eNB 104 may or may not configure the base station 106B as another C-SgNB to the UE 102.

When the base station 104 is an MgNB and the base station 106A is an SgNB, the UE 102 may be in NR-NR DC (NR-DC) with the MgNB and the SgNB. In this scenario, the MeNB 104 may or may not configure the base station 106B as a C-SgNB to the UE 102. When the base station 104 is an MgNB and the base station 106A is a C-SgNB for the UE 102, the UE 102 may be in SC with the MgNB. In this scenario, the MgNB 104 may or may not configure the base station 106B as another C-SgNB to the UE 102.

When the base station 104 is an MgNB and the base station 106A is a secondary ng-eNB (Sng-eNB), the UE 102 may be in NR-EUTRA DC (NE-DC) with the MgNB and the Sng-eNB. In this scenario, the MgNB 104 may or may not configure the base station 106B as a C-Sng-eNB to the UE 102. When the base station 104 is an MgNB and the base station 106A is a candidate Sng-eNB (C-Sng-eNB) for the UE 102, the UE 102 may be in SC with the MgNB. In this scenario, the MgNB 104 may or may not configure the base station 106B as another C-Sng-eNB to the UE 102.

FIG. 1B depicts an example, distributed or disaggregated implementation of any one or more of the base stations 104, 106A, 106B. In this implementation, the base station 104, 106A, or 106B includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The process hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to a NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to an Ethernet protocol layer (not shown in FIG. 2), an Internet Protocol (IP) layer (not shown in FIG. 2), Service Data Adaptation Protocol (SDAP) 212 and/or a radio resource control (RRC) sublayer (not shown in FIG. 2). The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer or a split bearer. The SN-terminated bearer can be an SCG bearer or a split bearer. The MN-terminated bearer can be an SRB (e.g., SRB1 or SRB2) or a DRB. The SN-terminated bearer can be an SRB or a DRB.

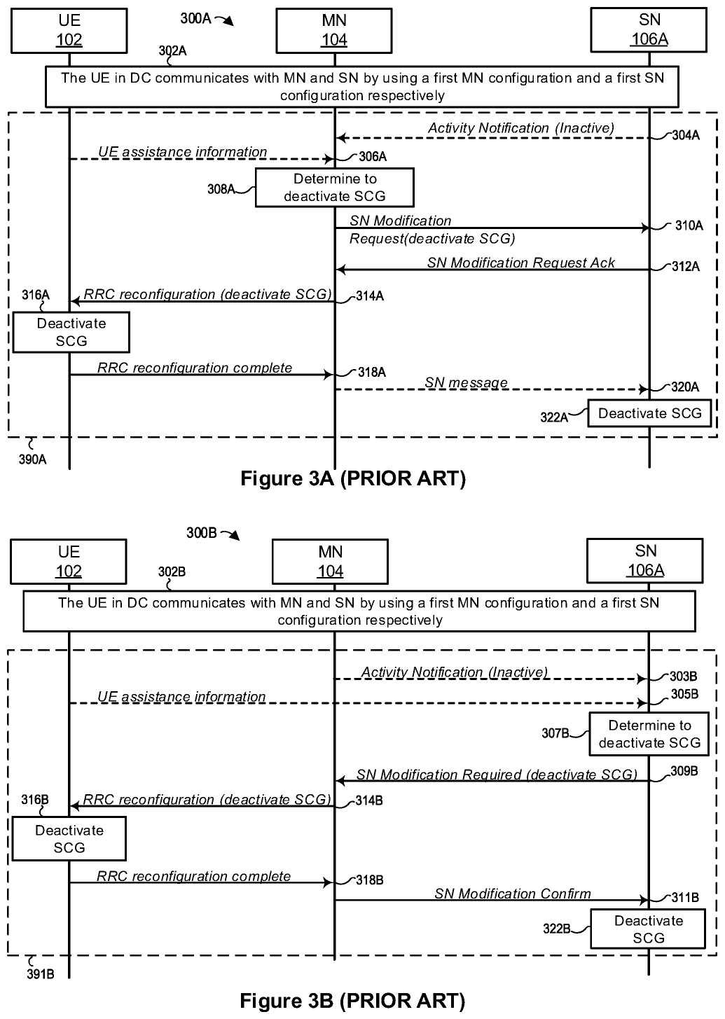

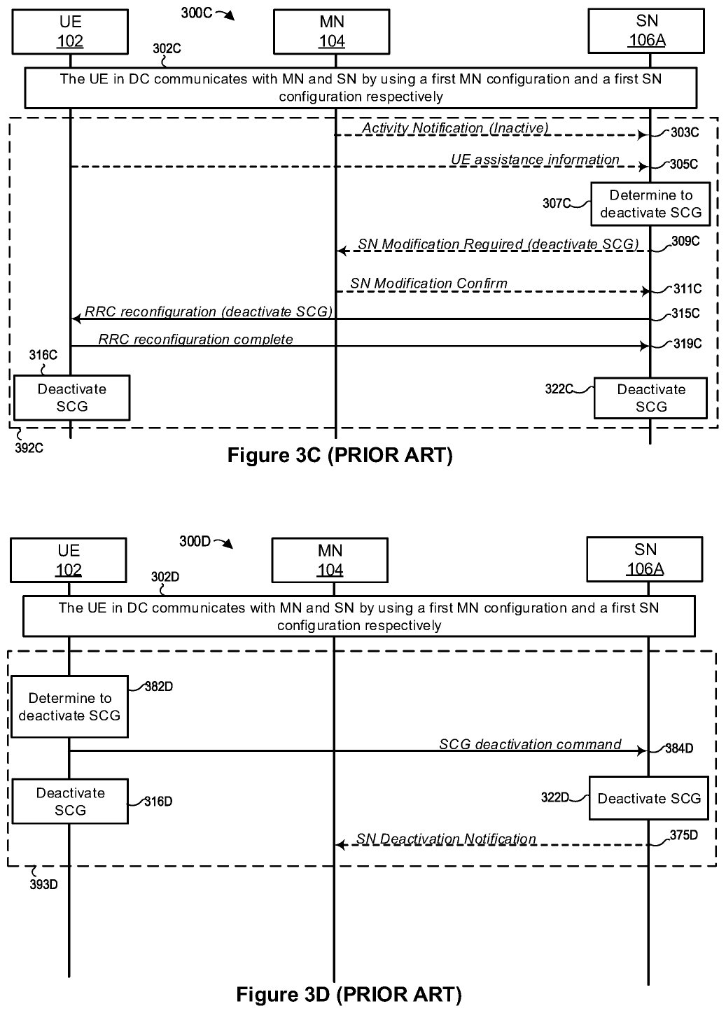

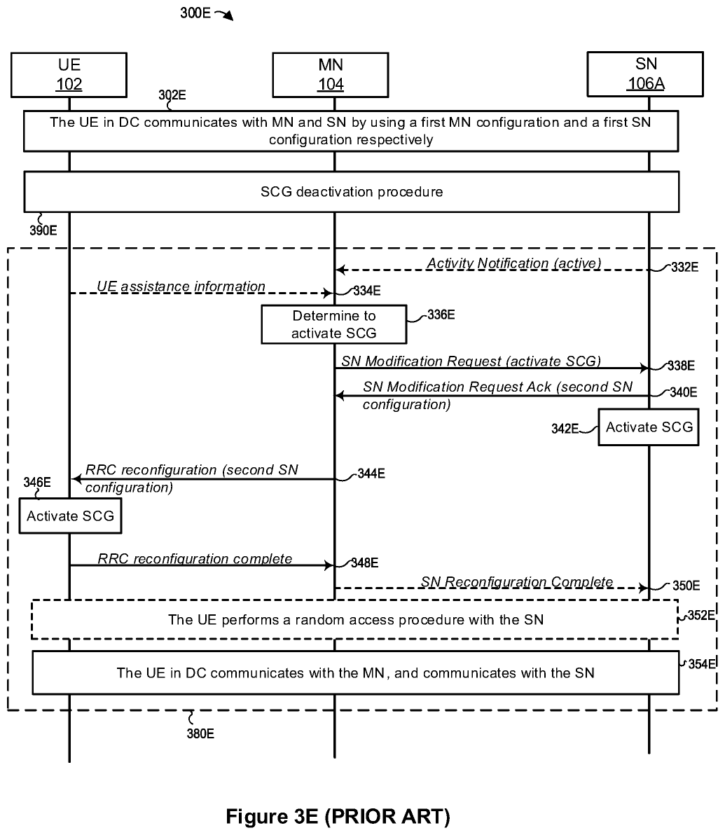

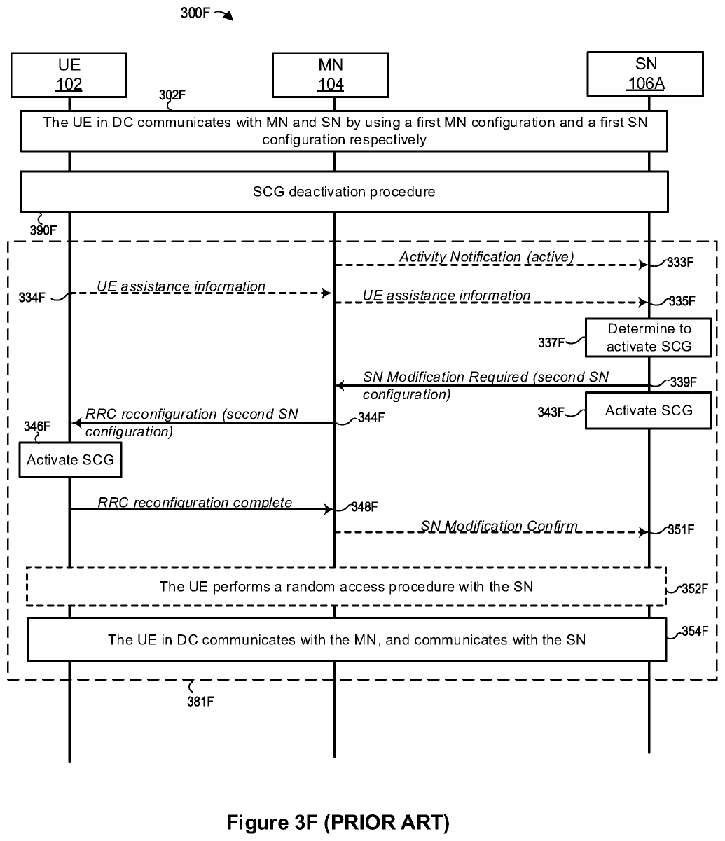

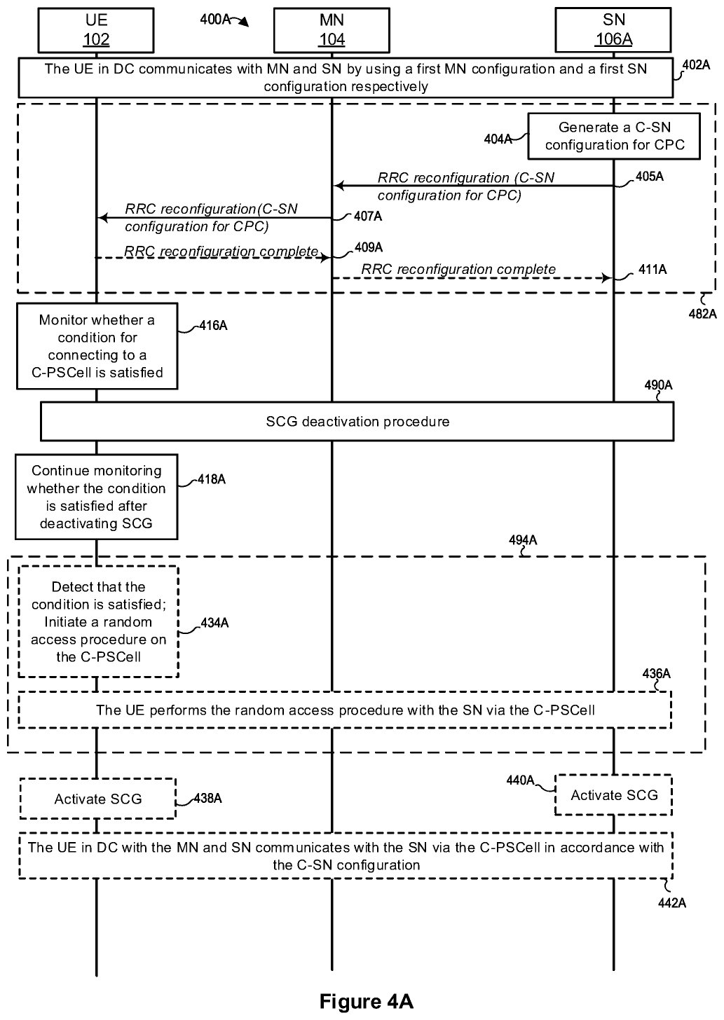

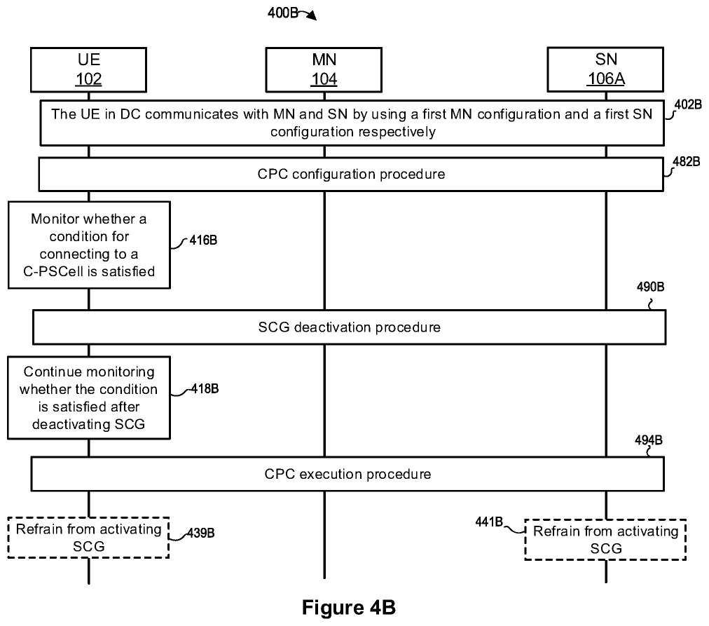

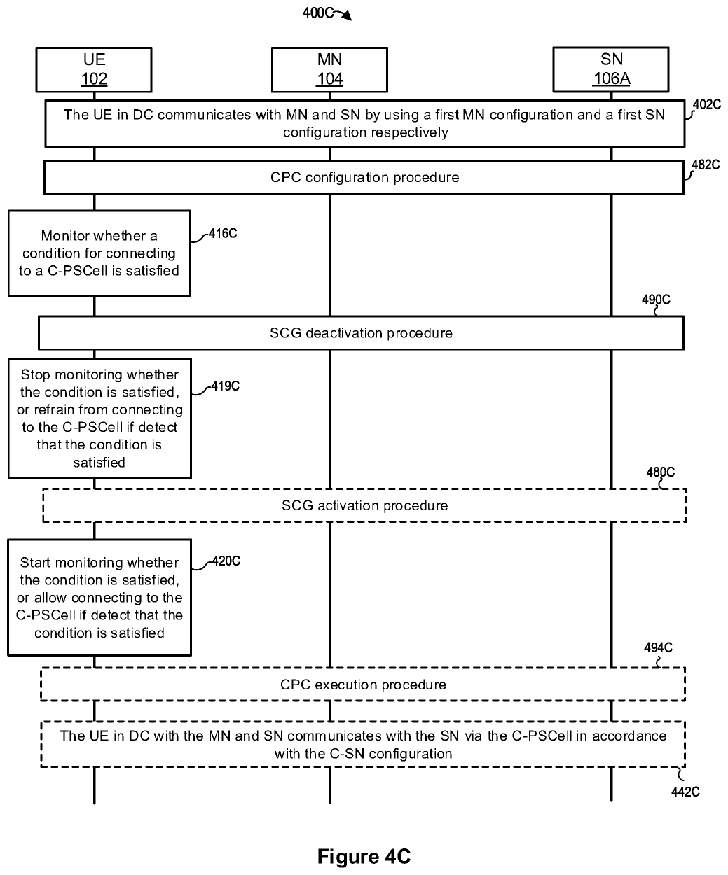

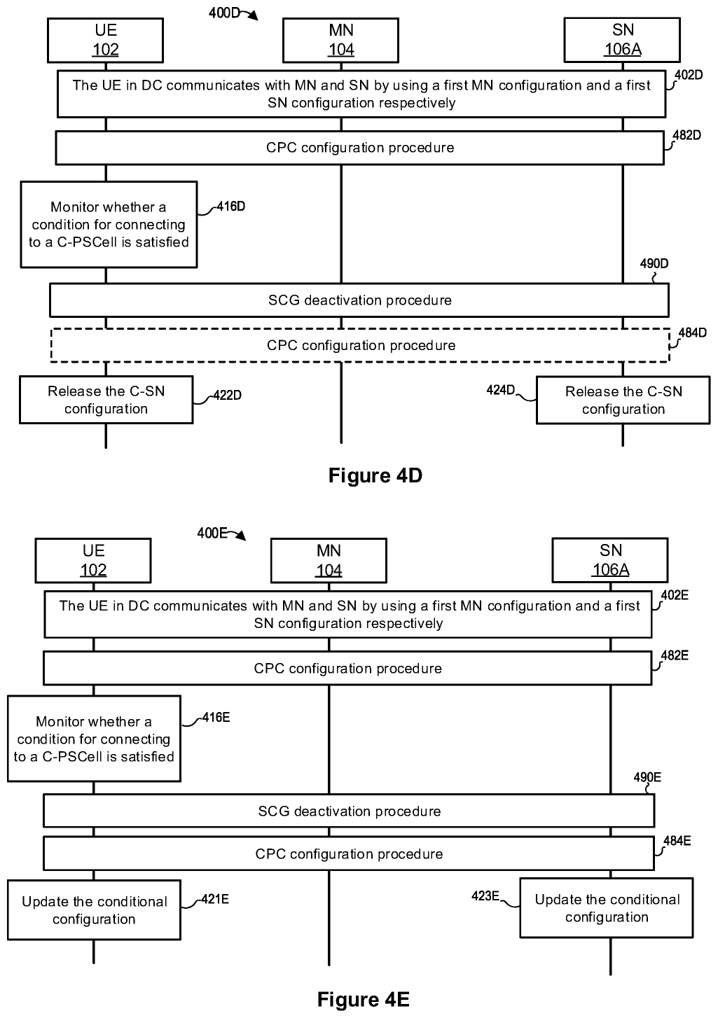

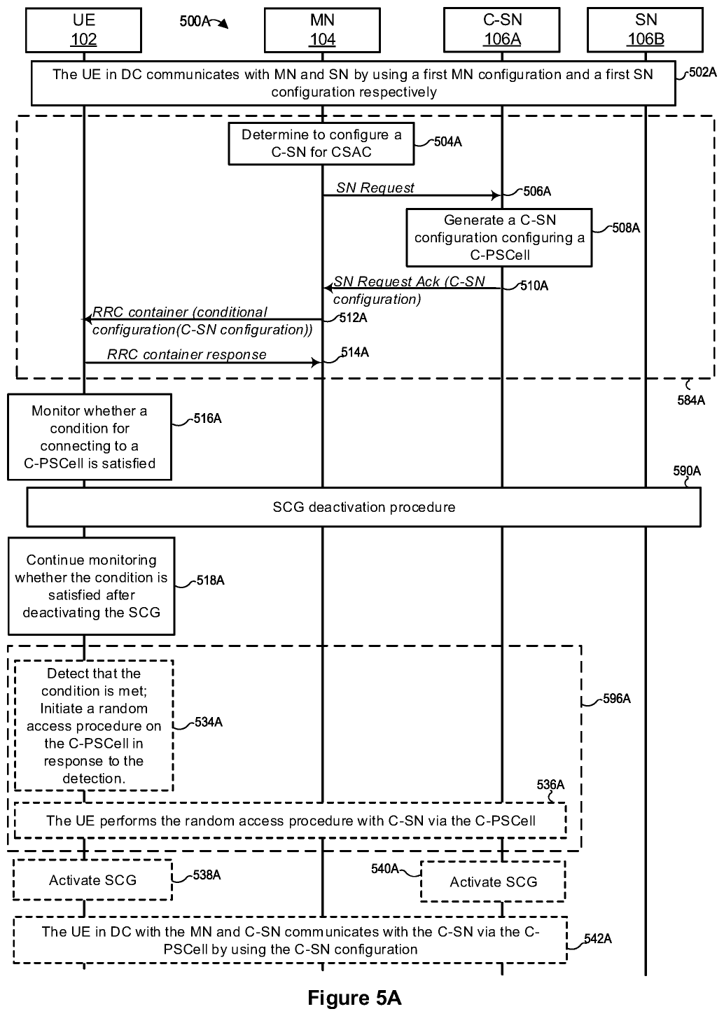

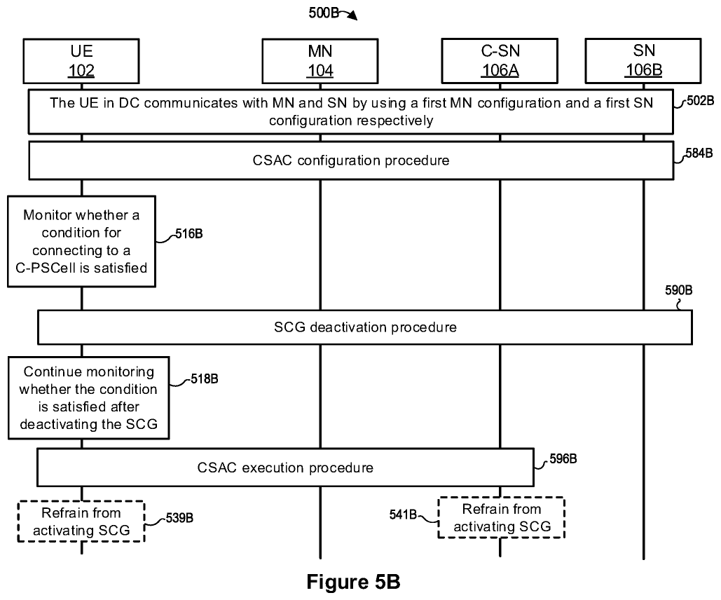

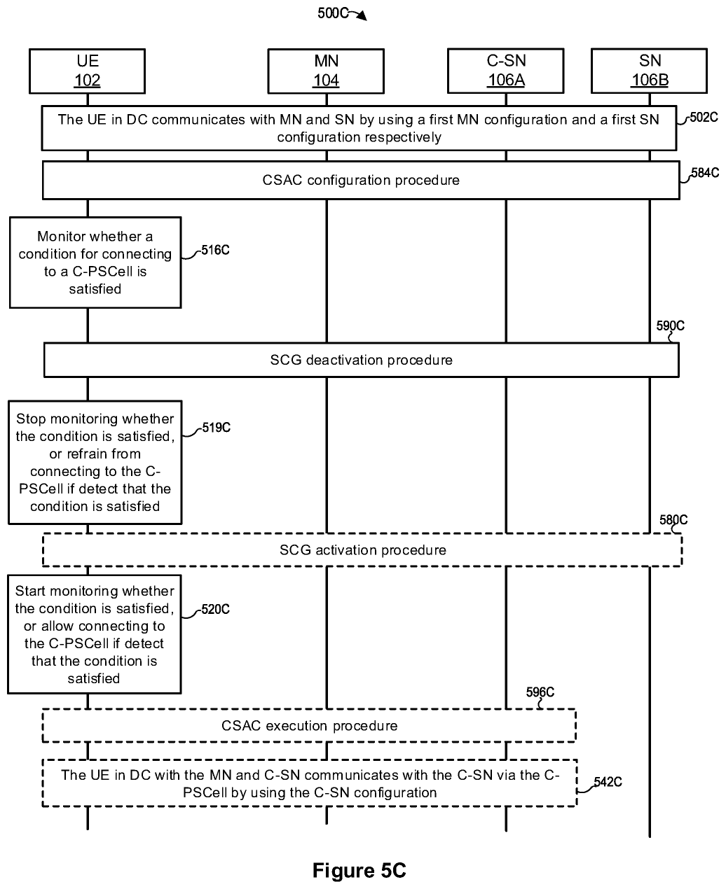

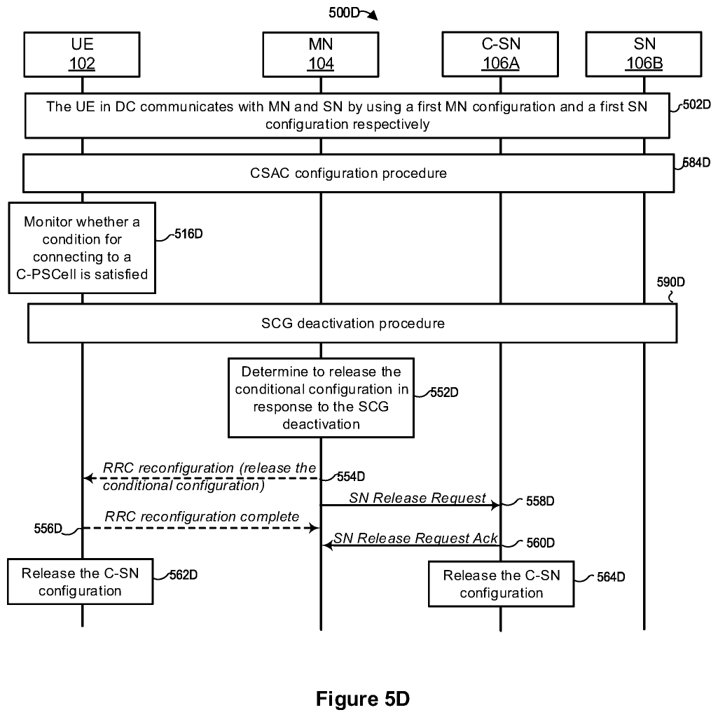

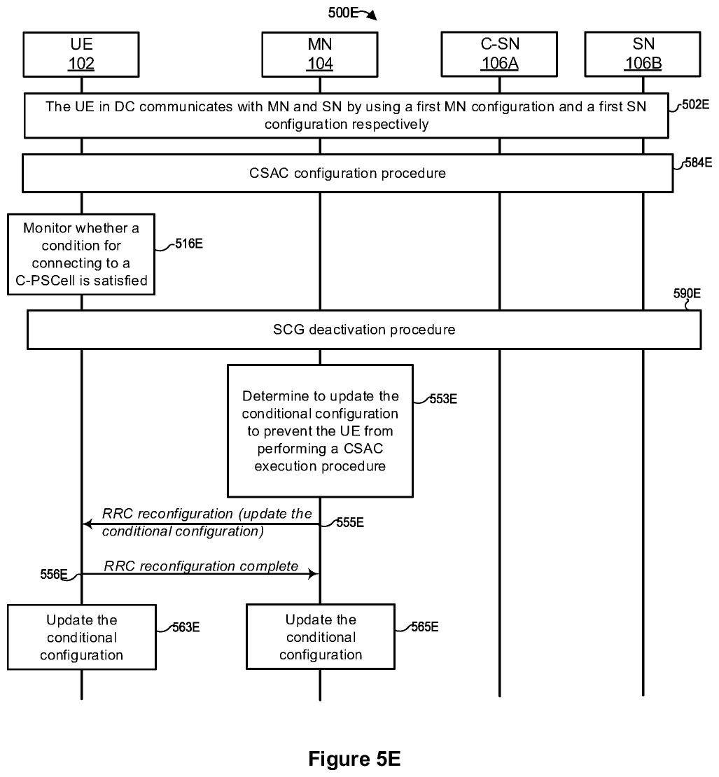

Next, several example scenarios in which the base stations operating in the system of FIG. 1A deactivate an SCG and/or activate the deactivated SCG (i.e., reactivate the SCG) between the UE 102 and the RAN 105 are discussed with reference to FIGS. 3A-3F. Further, scenarios in which the UE 102 and/or the RAN 105 manage conditional configurations related to conditional PSCell change (CPC) and CSAC procedures are discussed with reference to FIGS. 4A-4E and 5A-5E, respectively. Generally speaking, events in FIGS. 3A-3F that are similar are labeled with similar reference numbers (e.g., event 302A is similar to events 302B-F) with differences discussed below where appropriate. Likewise, events in FIGS. 4A-E that are similar are labeled with similar reference numbers (e.g., event 402A is similar to events 402B-E), with differences discussed below where appropriate. Events in FIGS. 5A-E that are similar are labeled with similar reference numbers (e.g., event 502A is similar to events 502B-E), with differences discussed below where appropriate.

Referring first to FIG. 3A, in a scenario 300A, the base station 104 operates as an MN, and the base station 106A operates as an SN. Initially, the UE 102 in DC communicates 302A data and control signals with the MN 104 and with SN 106A in accordance with a first MN configuration and a first SN configuration, respectively. For example, the control signals can include channel state information reference signals, tracking reference signals and/or physical downlink control channel (PDCCH) that the SN 106A transmits to the UE 102. In another example, the data includes a physical downlink shared channel (PDSCH) that the SN 106A transmits to the UE 102. In yet another example, the control signals can include sounding reference signals (SRSs), channel state information (CSI), channel quality indicator (CQI) and/or physical uplink control channel (PUCCH) that the UE 102 transmits to the SN 106A. In another example, the data includes a physical uplink shared channel (PUSCH) that the UE 102 transmits to the SN 106A.

In some implementations, the UE 102 in DC can communicate 302A UL PDUs and/or DL PDUs via radio bearers which can include SRBs and/or DRBs. The MN 104 and/or the SN 106A can configure the radio bearers to the UE 102. The UE 102 in DC communicates 302A UL PDUs and/or DL PDUs with the SN 106A on an SCG that the SN 106A configure for communication with the UE 102. The UE 102 in DC communicates with the MN 104 on an MCG and with the SN 106A on an SCG. In the first MN configuration, the MN 104 configures the MCG which includes at least one serving cell operated by the MN 104. In the first SN configuration, the SN 106A configures the SCG which includes at least one serving cell operated by the SN 106A. In some implementations, the first MN configuration includes multiple configuration parameters and the UE 102 receives the configuration parameters in one or more RRC messages from the MN 104. In other implementations, the first SN configuration includes multiple configuration parameters and the UE 102 receives the configuration parameters in one or more RRC messages from the SN 106A, e.g., via the MN 104 or on an SRB (e.g., SRB3) that the MN 104 or SN 106A configures to exchange RRC messages between the UE 102 and the SN 106A.

At a later time, the MN 104 determines 308A to deactivate the SCG for communication with the UE 102. In some implementations, the MN 104 can determine that data inactivity on the SCG exists for the UE 102 and, in response, determine 308A to deactivate the SCG for the UE 102. In one implementation, the MN 104 determines that data inactivity exists for the UE 102 based on a message for the UE 102 that the MN 104 receives from the SN 106A. For example, the SN 106A may detect data inactivity for the UE 102, and in response send 304A an Activity Notification message with an inactive indication for the UE 102 to the MN 104. The MN 104 can then determine that data inactivity exists for the UE 102 based on the received Activity Notification message. In another implementation, the MN 104 has not received data packets to be sent to the UE 102 via the SN 106A for a predetermined time period, so that the SN 106A may detect data inactivity exists for the UE 102. In yet another implementation, the MN 104 may detect data inactivity exists for the UE 102 if the MN 104 has neither received a request for data transmission from the UE 102 nor received data for the UE 102 from the CN 110 for a predetermined time period.

In other implementations, the MN 104 determines to deactivate the SCG for the UE 102 based on a UE preference that the MN 104 receives from the UE 102. For example, the UE 102 transmits 306A UE assistance information (e.g., UEAssistanceInformation message) to the MN 104, indicating the UE (temporarily) prefers single connectivity to save power or due to overheating. The MN 104 determines 308A to deactivate the SCG for the UE 102 in response to the UE assistance information received at event 306A.

In response to the determination 308A, the MN 104 sends 310A to the SN 106A an SN Modification Request message that deactivates the SCG for the UE 102. In response to the SN Modification Request message, the SN 106A sends 312A an SN Modification Request Acknowledge message to the MN 104. In some implementations, the MN 104 includes, in the SN Modification Request message the MN 104 transmits 310A, an indication (e.g., a field or an information element (IE)) to deactivate the SCG to cause the SN 106A to deactivate the SCG.

In response to the determination 308A, after the MN 104 transmits 310A the SN Modification Request message or after the MN 104 receives 312A the SN Modification Request Acknowledge message, the MN 104 transmits 314A an RRC reconfiguration message to cause the UE 102 to deactivate the SCG. In response to the RRC reconfiguration message, the UE 102 deactivates 316A the SCG for communication with the SN 106A and transmits 318A an RRC reconfiguration complete message to the MN 104. After deactivating the SCG, the UE 102 retains the radio connection with the MN 104. After receiving the RRC reconfiguration complete message, the MN 104 can send 320A an SN message (e.g., SN Reconfiguration Complete message) to the SN 106A to indicate that the UE 102 has deactivated the SCG. In some implementations, the MN 104 can generate an indication to deactivate the SCG and include the indication in the RRC reconfiguration message the MN 104 transmits 314A.

In some implementations, the UE 102 may stop or refrain from receiving data and/or control signals (e.g., as described for event 302A) on the SCG from the SN 106A after deactivating 316A the SCG (i.e., until the UE 102 activates the SCG). In other implementations, the UE 102 may stop or refrain from transmitting data and/or control signals (e.g., as described for event 302A) on the SCG to the SN 106A after deactivating 316A the SCG (i.e., until the UE 102 activates the SCG).

In some implementations, in response to or after deactivating the SCG, the UE 102 can release or suspend protocol layer(s) and/or entity/entities (e.g., PHY 202A/202B, MAC 204A/204B, RLC 206A/206B) that the UE 102 uses to communicate with the SN 106A, so that the UE 102 stops or refrains from receiving and/or transmitting the data and/or control signals from/to the SN 106A on the SCG.

In some implementations, the SN 106A can include an additional SN configuration in the SN Modification Request Acknowledge message 312A and the MN 104 includes the additional SN configuration in the RRC reconfiguration message 314A. In some implementations, the SN 106A generates the additional SN configuration as a delta SN configuration which augments only a portion of the first SN configuration. Accordingly, the UE 102 augments only a portion of the first SN configuration with the delta SN configuration and retains the portion of the first SN configuration that is not augmented by the delta SN configuration. In other implementations, the SN 106A generates the additional SN configuration as a complete and self-contained configuration (i.e. a full SN configuration). The UE 102 replaces the first SN configuration with the additional SN configuration. In yet other implementations, the SN 106A does not include an SN configuration in the SN Modification Request Acknowledge message 312A. In some implementations, the SN 106A can generate an indication to deactivate the SCG and include the indication in the additional SN configuration. In such implementations, the MN 104 may not include an indication to deactivate the SCG in the RRC reconfiguration 314A.

In some implementations, the MN 104 can also include a second MN configuration in the RRC reconfiguration message the MN 104 transmits 314A, in which case, the UE 102 communicates with the MN 104 using the second MN configuration after receiving 314A the RRC reconfiguration message. In some implementations, the MN 104 generates the second MN configuration as a delta MN configuration which augments only a portion of the first MN configuration. Accordingly, the UE 102 communicates with the MN 104 using the delta MN configuration and the portion of the first MN configuration that is not augmented by the delta MN configuration. In other implementations, the MN 104 does not include an MN configuration in the RRC reconfiguration message the MN 104 transmits 314A.

The SN 106A can deactivate 322A the SCG for communication with the UE 102 in response to receiving 310A the SN Modification Request message, after transmitting 312A the SN Modification Request Acknowledge message, or after receiving 320A the SN message. In some implementations, the SN 106A may stop or refrain from transmitting data and/or control signals (e.g., as described for event 302A) to the UE 102 after deactivating 322A the SCG (i.e., until the SN 106A activates the SCG for the UE 102). In some implementations, in response to or after deactivating the SCG, the SN 106A can release or suspend protocol layer(s) and/or entity/entities (e.g., PHY 202A/202B, MAC 204A/204B, RLC 206A/206B) that the SN 106A uses to communicate with the UE 102, so that the SN 106A stops or refrains from transmitting the data and/or control signal to the UE 102 on the SCG.

The events 304A, 306A, 308A, 310A, 312A, 314A, 316A, 318A, 320A and 322A are collectively referred to in FIG. 3A as an SCG deactivation procedure 390A.

In some implementations, the MN configuration (i.e., first MN configuration and/or the second MN configuration) can include multiple configuration parameters that configure radio resources for the UE 102 to communicate with the MN 104 via a PCell (e.g., the cell 124 or a cell other than cell 124) and zero, one, or more secondary cells (SCells) of the MN 104. For example, the first MN configuration can include PHY configuration(s), MAC configuration(s), and/or RLC configuration(s). In another example, the MN configuration can include one or more measurement configurations. The MN configuration can include one or more radio bearer configurations configuring one or more radio bearers. The UE 102 may receive the multiple configuration parameters in one or more RRC messages from the MN 104.

In some implementations, the MN configuration includes configuration parameters in an RRCReconfiguration message, RRCReconfiguration-IEs, or the CellGroupConfig information element (IE) conforming to 3GPP TS 38.331. In one implementation, the MN configuration can be an RRCReconfiguration message, RRCReconfiguration-IEs, or the CellGroupConfig IE conforming to 3GPP TS 38.331. In other implementations, the MN configuration can include configuration parameters in a RadioResourceConfigDedicated IE, RRCConnectionReconfiguration message, or RRCConnectionReconfiguration-IEs. In one implementation, the MN configuration can be a RadioResourceConfigDedicated IE, an RRCConnectionReconfiguration message, or an RRCConnectionReconfiguration-IEs conforming to 3GPP TS 36.331.

The SN configuration (i.e., first SN configuration or additional SN configuration) can include multiple configuration parameters that configure radio resources for the UE 102 to communicate with the SN 106A via a PSCell (e.g., the cell 126A or a cell other than cell 126A) and zero, one, or more SCells of the SN 106A. For example, the SN configuration can include PHY configuration(s), MAC configuration(s), and/or RLC configuration(s). The SN configuration may or may not include measurement configuration(s). In some implementations, the SN configuration may not include one or more radio bearer configurations (e.g., RadioBearerConfig, SRB-ToAddMod or DRB-ToAddMod) configuring one or more radio bearers.

In some implementations, the SN configuration includes configuration parameters in an RRCReconfiguration message, RRCReconfiguration-IEs, or a CellGroupConfig IE conforming to 3GPP TS 38.331. In one implementation, the SN configuration can be an RRCReconfiguration message, RRCReconfiguration-IEs, or a CellGroupConfig IE conforming to 3GPP TS 38.331. In other implementations, the SN configuration can include configuration parameters in an SCG-ConfigPartSCG-r12 IE. In some implementations, the SN configuration can be an RRCConnectionReconfiguration message, RRCConnectionReconfiguration-IEs, or a ConfigPartSCG-r12 IE conforming to 3GPP TS 36.331.

If the MN 104 is a gNB, the RRC reconfiguration message and the RRC reconfiguration complete message are RRCReconfiguration message and RRCReconfigurationComelete message, respectively. If the MN 104 is an eNB or ng-eNB, the RRC reconfiguration message and the RRC reconfiguration complete message are RRCConnectionReconfiguration message and RRCConnectionReconfigurationComelete message, respectively.

Referring next to FIG. 3B, a scenario 300B, the base station 104 operates as an MN and the base station 106A operates as an SN. The scenario 300B is generally similar to the scenario 300A, but with the SN 106A, rather than the MN 104, determining to deactivate the SCG. As mentioned above, events in the scenario 300B similar to those discussed above with respect to the scenario 300A are labeled with similar reference numbers (e.g., with event 302A of FIG. 3A corresponding to event 302B of FIG. 3B). With the exception of the differences shown in FIG. 3B and the differences described below, any of the alternative implementations discussed above with respect to the scenario 300A (e.g., for messaging and processing) may apply to the scenario 300B.

After event 302B, the SN 106A determines 307B to deactivate the SCG for communication with the UE 102. In some implementations, the SN 106A can determine that data inactivity on the SCG exists for the UE 102 and, in response, determine 307B to deactivate the SCG for the UE 102. In one implementation, the SN 106A has neither received data packets to be sent to the UE 102 from the CN 110 nor received data packets from the UE 102 for a predetermined time period, so that the SN 106A may detect data inactivity exists for the UE 102.

In other implementations, the SN 106A determines 307B to deactivate the SCG for the UE 102 based on a UE preference that the SN 106A receives from the UE 102 e.g., via the MN 104 or on an SRB (e.g., SRB3) that the MN 104 or SN 106A configures to exchange RRC messages between the UE 102 and the SN 106A. For example, the UE 102 sends 305B UE assistance information (e.g., UEAssistanceInformation message) to the SN 106A, indicating the UE (temporarily) prefers single connectivity to save power or due to overheating. The SN 106A determines 307B to deactivate the SCG for the UE 102 in response to the UE assistance information received at event 305B. In some implementations, the SN 106A receives 305B the UE assistance information from the UE 102 via the MN 104.

In yet other implementations, the MN 104 detects data inactivity for the UE 102 and sends 303B an Activity Notification message with an inactive indication for the UE 102 to the SN 106A. The SN 106A determines 307B to deactivate the SCG for the UE 102 based on the Activity Notification message.

In response to the determination 307B, the SN 106A sends 309B to the MN 104 an SN Modification Required message that requests to deactivate the SCG for the UE 102. In response to the request to deactivate the SCG, the MN 104 transmits 314B an RRC reconfiguration message to the UE 102, similar to event 314A. The UE 102 deactivates 316B the SCG and transmits 318B an RRC reconfiguration complete message to the MN 104 in response to the RRC reconfiguration message the UE 102 receives 314B, similar to events 316A and 318A respectively. After receiving 318B the RRC reconfiguration complete message, the MN 104 sends 311B an SN Modification Confirm message to the SN 106A to indicate that the UE 102 has deactivated the SCG, in response to the SN Modification Required message. Alternatively, the MN 104 can send the SN Modification Confirm message to the SN 106A before receiving 318B the RRC reconfiguration complete message in response to the SN Modification Required message.

In some implementations, the SN 106A includes, in the SN Modification Required message the SN 106A transmits 309B, an indication (e.g., a field or an information element (IE)) to deactivate the SCG to cause the MN 104 to transmit 314B the RRC reconfiguration message to deactivate the SCG. The SN 106A deactivates 322B the SCG after determining 307B to deactivate the SCG. In some implementations, the SN 106A deactivates 322B the SCG after receiving 311B the SN Modification Confirm message.

In some implementations, the MN 104 generates an indication (e.g., a field or IE) to deactivate the SCG and includes the indication in the RRC reconfiguration message 314B. In other implementations, the SN 106A generates an additional SN configuration including an indication (e.g., a field or an IE) to deactivate the SCG and includes the additional SN configuration in the SN Modification Required message. The MN 104 can include the additional SN configuration in the RRC reconfiguration message the MN 104 transmits 314B without generating an indication to deactivate the SCG. The UE 102 deactivates 316B the SCG in response to the indication received in the RRC reconfiguration message 314B.

The events 303B, 305B, 307B, 309B, 311B, 314B, 316B, 318B, 311B and 322B are collectively referred to in FIG. 3B as an SCG deactivation procedure 391B.

Referring next to FIG. 3C, in a scenario 300C, the base station 104 operates as an MN, and the base station 106A operates as an SN. The scenario 300C is generally similar to the scenarios 300A and 300B, except that the UE 102 communicates directly with the SN 106A. With the exception of the differences shown in FIG. 3C and the differences described below, any of the alternative implementations discussed above with respect to the scenarios 300A and 300B (e.g., for messaging and processing) may apply to the scenario 300C.

In response to determining 307C to deactivate the SCG, the SN 106A generates an RRC message to deactivate the SCG and transmits 315C the RRC reconfiguration message to the UE 102 on an SRB (e.g., SRB3) that the MN 104 or SN 106A configures to exchange RRC messages between the UE 102 and the SN 106A. In response, the UE 102 deactivates 316C the SCG. The UE 102 can transmit 319C an RRC reconfiguration complete message to the SN 106A on the SRB in response to the RRC reconfiguration message. Alternatively, the SN 106A transmits 315C the RRC reconfiguration message to the UE 102 via the MN 104. The UE 102 can transmit 319C the RRC reconfiguration complete message to the SN 106A via the MN 104.

In some implementations, if the UE 102 is required to transmit the RRC reconfiguration complete message, the UE 102 can transmit 319C the RRC reconfiguration complete message before or after deactivating the SCG. In other implementations, the SN 106A deactivates 322C the SCG after determining 307C to deactivate the SCG or transmitting 315C the RRC reconfiguration message. In yet other implementations, if the UE 102 transmits the RRC reconfiguration complete message, the SN 106A deactivates 322C the SCG after receiving 319C the RRC reconfiguration complete message. In yet other implementations, the SN 106A deactivates 322C the SCG after receiving an acknowledgement message from the UE 102, acknowledging that the UE 102 receives PDU(s) including the RRC reconfiguration message. For example, the acknowledgement message can be an RLC acknowledgement PDU or a hybrid Automatic Repeat Request (HARQ) acknowledgement.

In some implementations, the SN 106A can send 309C to the MN 104 an SN Modification Required message to obtain a permission from the MN 104 to deactivate the SCG after determining 307C to deactivate the SCG. The MN 104 can send 311C to the SN 106A an SN Modification Confirm message indicating the MN 104 permits the SN 106A to deactivate the SCG. After obtaining the permission, the SN 106A transmits 315C the RRC reconfiguration message to the UE 102.

In other implementations, the SN 106A does not need permission from the MN 104. The SN 106A can send 309C to the MN 104 an SN message (e.g., SN Modification Required message, SN Deactivation Notification message, or an X2 or Xn interface message) indicating that the SCG is deactivated after determining 307C to deactivate the SCG. In one implementation, the SN 106A can send the SN message before or after transmitting 315C the RRC reconfiguration message. In another implementation, the SN 106A can send 309C the SN message before or after receiving 319C the RRC reconfiguration complete message.

The events 303C, 305C, 307C, 309C, 311C, 315C, 316C, 319C, and 322C are collectively referred to in FIG. 3C as an SCG deactivation procedure 392C.

Referring next to FIG. 3D, in a scenario 300D, the base station 104 operates as an MN, and the base station 106A operates as an SN. The scenario 300D is generally similar to the scenarios 300A-C, but with the UE 102 determining to deactivate the SCG. With the exception of the differences shown in FIG. 3D and the differences described below, any of the alternative implementations discussed above with respect to the scenarios 300A-C (e.g., for messaging and processing) may apply to the scenario 300D.

The UE 102 in DC determines 382D to deactivate the SCG. For example, the UE 102 can determine 382D to deactivate the SCG based on a power level at the UE, or based on whether the UE 102 has data to transmit via the SCG or expects to receive data via the SCG. In response to the determination, the UE 102 transmits 384D an SCG deactivation command to the SN 106A on an SRB (e.g., SRB3) that the MN 104 or SN 106A configures to exchange RRC messages between the UE 102 and the SN 106A. Alternatively, the UE 102 transmits the SCG deactivation command to the SN 106A via the MN 104. The SN 106A deactivates 322D the SCG in response to the SCG deactivation command. The SN 106A may send 375D to the MN 104 an SN message (e.g., SN Modification Required message, SN Deactivation Notification message or an X2 or Xn interface message) indicating that the SCG is deactivated. The UE 102 deactivates 316D the SCG at the UE 102 after determining 382D to deactivate the SCG or after transmitting 384D the SCG deactivation command. The events 382D, 384D, 316D, 322D, and 375D are collectively referred to in FIG. 3D as an SCG deactivation procedure 393D.

Referring next to FIG. 3E, in a scenario 300E, the base station 104 operates as an MN, and the base station 106A operates as an SN. The scenario 300E is generally similar to the scenarios 300A-D, but with the MN 104 determining to activate the SCG. With the exception of the differences shown in FIG. 3E and the differences described below, any of the alternative implementations discussed above with respect to the scenarios 300A-D (e.g., for messaging and processing) may apply to the scenario 300E.

Initially, the UE 102 operates 302E in DC with the MN 104 and SN 106A. The UE 102 can then perform 390E an SCG deactivation procedure, similar to the SCG deactivation procedure 390A, 391B, 392C, or 393D. After deactivating the SCG during the SCG deactivation procedure 390E, the MN 104 can determine 336E to activate the SCG for communication with the UE 102. In some implementations, the MN 104 can determine that data activity on the SCG exists for the UE 102 and, in response, determine 336E to activate the SCG for the UE 102. For example, the MN 104 determines that data activity exists for the UE 102 based on a message for the UE 102 that the MN 104 receives from the SN 106A. For example, the SN 106A may detect data activity for the UE 102, and in response send 332E an Activity Notification message with an active indication for the UE 102 to the MN 104. The MN 104 can then determine that data activity exists for the UE 102 based on the received Activity Notification message. In some implementations, the SN 106A may receive data packets for the UE 102 from the CN 110 so that the SN 106A may detect data activity for the UE 102. In yet other implementations, the MN 104 makes the determination 336E in response to receiving data, or a large volume of data (e.g., in excess of some value Vₘᵢₙ configured by the network operator, the MN manufacturer, and/or specified on a per-flow basis, a per-session basis, or some other suitable basis), for the UE 102 from the CN 110 or the SN 106A. For example, if a data volume that the MN 104 receives from the CN 110 or SN 106A is above a preconfigured, predetermined, or static threshold, the MN 104 determines that the data volume is a large volume. In yet other implementations, the MN 104 makes the determination 336E in response to receiving data associated to a specific QoS (flow) or a particular PDU Session for the UE 102 from the CN 110 or the SN 106A.

In other implementations, the MN 104 receives data packets that the MN 104 will send to the UE 102 via the SN 106A, so that the MN 104 may determine to activate the SCG in response to receiving the data packets. The MN 104 can transmit the data packets to the UE 102 via the MCG. In yet other implementations, the MN 104 receives data packets for the UE 102 from the SN 106A, which causes the MN 104 determine to activate the SCG. The MN 104 can transmit the data packets to the UE 102 via the MCG.

In yet other implementations, the MN 104 determines to activate the SCG for the UE 102 based on a UE preference that the MN 104 receives from the UE 102. For example, the UE 102 sends 334E UE assistance information (e.g., UEAssistanceInformation message) indicating the UE 102 (temporarily) prefers dual connectivity or has data to transmit on the SCG. The MN 104 determines 336E to activate the SCG for the UE 102 in response to the UE assistance information received at event 334E.

In yet other implementations, the MN 104 determines to activate the SCG for the UE 102 based on one or more measurement results received from the UE. If measurement result(s) for cell 126A are above a first threshold and/or measurement result(s) for cell 125A are below a second threshold, the MN 104 can determine to activate the SCG for the UE 102. Alternatively, the MN 104 refrains from activating the SCG even though measurement result(s) for cell 126A are above a first threshold and/or measurement result(s) for cell 125A (i.e., the current PSCell) are below a second threshold.

In response to the determination 336E, the MN 104 sends 338E to the SN 106A an SN Modification Request message which activates the SCG for the UE 102. In response to 338E the SN Modification Request message, the SN 106A sends 340E an SN Modification Request Acknowledge message to the MN 104 and activates 342E the SCG. In some implementations, the SN 106A can include a second SN configuration in the 340E SN Modification Request Acknowledge message. For example, the SN 106A can include, in the second SN configuration, random access configuration(s) for the UE 102 to perform 352E a random access procedure with the SN 106A. In other implementations, the SN 106A does not include an SN configuration in the SN Modification Request Acknowledge message the SN transmits 340E.

In some implementations, the MN 104 does not include the indication to deactivate the SCG in the SN Modification Request message the MN 104 transmits 338E to cause the SN 106A to activate the SCG. In other implementations, the MN 104 generates an indication to activate the SCG and includes the indication in the SN Modification Request message the MN 104 transmits 338E to cause the SN 106A to activate the SCG. In yet other implementations, the MN 104 generates an indication to resume lower layers and includes the indication in the SN Modification Request message the MN 104 transmits 338E to cause the SN 106A to activate the SCG. In this case, the MN 104 may or may not include the indication activating the SCG in the SN Modification Request message the MN 104 transmits 338E.

In response to the determination 336E, after the MN 104 transmits 338E the SN Modification Request message or after the MN 104 receives 340E the SN Modification Request Acknowledge message, the MN 104 transmits 344E an RRC reconfiguration message to cause the UE 102 to activate the SCG. In response to the RRC reconfiguration message, the UE 102 activates 346E the SCG for communication with the SN 106A and transmits 348E an RRC reconfiguration complete message to the MN 104. After receiving 348E the RRC reconfiguration complete message, the MN 104 can send 350E an SN Reconfiguration Complete message to the SN 106A to indicate that the UE 102 has activated the SCG.

In some implementations, the MN 104 can include an indication to activate the SCG in the RRC reconfiguration message the MN 104 transmits 344E. In other implementations, the MN 104 does not include an indication to activate the SCG in the RRC reconfiguration message the MN 104 transmits 344E. In yet other implementations, the SN 106A includes an indication to activate the SCG in the second SN configuration.

In some implementations, the UE 102 includes, in the RRC reconfiguration complete message the UE 102 transmits 348E, a second RRC reconfiguration complete message responding to receiving the second SN configuration. The MN 104 can include the second RRC reconfiguration complete message in the SN Reconfiguration Complete message so that the SN 106A can receive the second RRC reconfiguration complete message. If the SN 106A is a gNB, the second RRC reconfiguration complete message is an RRCReconfigurationComplete message. If the SN 106A is an ng-eNB, the second RRC reconfiguration complete message is an RRCConnectionReconfigurationComplete message.

At some point after receiving 344E the RRC reconfiguration message or in response to the RRC reconfiguration message, the UE 102 in some implementations can perform 352E a random access procedure on cell 125A with the SN 106A to activate the SCG with the SN 106A. In some implementations, the UE 102 performs the random access procedure using one or more random access configurations in the second SN configuration the UE receives 344E. For example, the SN 106A can include the random access configuration(s) in a SpCellConfig IE, a ReconfigurationWithSync IE, or a ServingCellConfigCommon IE and include the SpCellConfig IE ReconfigurationWithSync IE, or ServingCellConfigCommon IE in the second SN configuration. In other implementations, the UE 102 performs 352E the random access procedure using one or more random access configurations that the UE 102 received from the SN 106A before activating or deactivating the SCG. In yet other implementations, the UE 102 does not perform a random access procedure with the SN 106A to activate the SCG with the SN 106A. For example, the SN 106A excludes the SpCellConfig IE, ReconfigurationWithSync IE, or ServingCellConfigCommon IE in the second SN configuration to indicate that the UE 102 is not to perform a random access procedure with the SN 106A. Thus, the UE 102 activates the SCG with the SN 106A without performing a random access procedure in accordance with the SN configuration excluding the SpCellConfig IE, ReconfigurationWithSync IE, or ServingCellConfigCommon IE.

In some implementations, the SN 106A may indicate to the UE 102 to perform a random access procedure in the second SN configuration to activate the SCG. For example, the SN 106A can include an indication to perform a random access procedure in the second SN configuration. In this example, the second SN configuration excluding the indication to perform a random access procedure may alternatively indicate the UE 102 to not perform a random access procedure to activate the SCG. In other implementations, the SN 106A may indicate to the UE 102 to refrain from performing a random access procedure to activate the SCG. For example, the SN 106A can include an indication to not perform a random access procedure in the second SN configuration.

In some implementations, the SN 106A determines whether the UE 102 needs to perform a random access procedure to activate the SCG based on an uplink synchronization timer that the SN 106A starts before deactivating the SCG for the UE 102. Before deactivating the SCG for the UE 102, the SN 106A starts the uplink synchronization timer in response to transmitting a timing advance command to the UE 102 in a MAC PDU. If the uplink synchronization timer is still running before deactivating the SCG, the SN 106A maintains the uplink synchronization timer while or after deactivating the SCG. When the SN 106A determines to activate the SCG or generates the second SN configuration, if the uplink synchronization timer is still running, the SN 106A may exclude the random access configuration(s) or may indicate to the UE 102 to not perform a random access procedure in the second SN configuration. In some implementations, if the SN 106A estimates that the uplink synchronization timer will expire during the SCG activation procedure, the SN 106A includes the random access configuration(s) or indicates to the UE 102 to perform a random access procedure in the second SN configuration.

In some implementations, the UE 102 may refrain from performing the random access procedure with the SN 106A if the UE 102 determines that the UE 102 is synchronized with the SN 106A on cell 125A (i.e., PSCell) for uplink transmission. In this case, the UE 102 may (start to) transmit CSI or CQI on a PUCCH and/or SRS on the cell 125A after activating the SCG. If the UE 102 determines that the UE 102 is not synchronized with the SN 106A, the UE 102 performs 352E the random access procedure with the SN 106A. For example, the UE 102 can determine that the UE 102 is synchronized with the SN 106A for uplink transmission if the UE 102 maintains a time alignment timer associated with the SCG and the timer alignment timer is running. Otherwise, if the timer alignment stops or expires, the UE 102 determines that the UE 102 is not synchronized with the SN 106A for uplink transmission. In another example, the UE 102 determines that the UE 102 is synchronized with the SN 106A on cell 125A for uplink transmission if the UE 102 determines that a time alignment value associated to the cell 125A is valid. If the UE 102 determines the time alignment value associated to the cell 125A is invalid, the UE 102 determines that the UE 102 is not synchronized with the SN 106A in uplink transmission.

In some implementations, after the UE 102 deactivates 346E the SCG, the UE 102 performs measurements on cell 125A and obtains a signal strength and/or quality from the measurements. If the signal strength and/or quality has neither increased by more than a first threshold nor decreased by more than a second threshold, the UE 102 can determine that the time alignment value associated to the cell 125A is valid. Otherwise, the UE 102 can determine that the time alignment value associated to the cell 125A is invalid. In some implementations, the UE 102 can receive from the SN 106A or MN 104 a threshold configuration configuring the first threshold and/or the second threshold. The first and second thresholds can be the same or different. In some implementations, the UE 102 can receive the threshold configuration, e.g., in a (the) RRC reconfiguration message, a (the) SN configuration, or an over-the-air (OTA) message, at event 302E or 390E or 344E. In other implementations, the first and/or second thresholds are predetermined and stored at the UE 102.

In some implementations, the UE 102 can obtain a pathloss based on measurements that UE 102 made on cell 125A. If the pathloss is within a value range, the UE 102 can determine that the time alignment value associated to the cell 125A is valid. Otherwise, the UE 102 can determine that the time alignment value associated to the cell 125A is invalid. In some implementations, the UE 102 can receive from the SN 106A or MN 104 a value range configuration configuring the value range. In other implementations, the value range is predetermined and stored at the UE 102.

If the UE 102 performs 352E the random access procedure, after successfully completing 352E the random access procedure on the cell 125A with the SN 106A, the UE 102 can communicate 354E data and/or control signals (e.g., as described for event 302A) in DC with both the MN 104 and the SN 106A through the cell 124A and the cell 125A, respectively. Having identified the UE 102 in the random access procedure, the SN 106A can communicate 354E data and/or control signals (e.g., as described for event 302A) with the UE 102 in accordance with configuration parameters in the first SN configuration, additional SN configuration and/or second SN configuration. If the UE 102 does not perform a random access procedure to activate the SCG in response to the RRC reconfiguration message 344E, the UE 102 can communicate 354E data and/or control signals (e.g., as described for event for 302A) in DC with both the MN 104 and the SN 106A through the cell 124 and cell 125A respectively.

In some implementations, the SN 106A can include new configuration parameters for the SCG in the second SN configuration. The UE 102 uses the new configuration parameters to communicate 354E data and control signals with the SN 106A after activating the SCG. For example, the new configuration parameters can change the PSCell, modify the current PSCell or a SCell, release a SCell, or add a new SCell. In another example, the new configuration parameters can include configuration parameters for operation of PHY 202A/202B, MAC 204A/204B or RLC 206A/206B. In another implementations, the SN 106A can indicate, in the second SN configuration, to release configuration parameter(s) included in the first SN configuration or additional SN configuration. Thus, the UE 102 releases the configuration parameter(s) and does not use the released configuration parameter(s) to communicate 354E data and/or control signals with the SN 106A after activating the SCG. If the RRC reconfiguration message that the UE 102 receives 344E does not include an SN configuration, the UE 102 communicates 354E data and/or control signals with the SN 106A using configuration parameters in the first SN configuration.

The events 332E, 334E, 336E, 338E, 340E, 342E, 344E, 346E, 348E, 350E, 352E, and 354E are collectively referred to in FIG. 3E as an SCG activation procedure 380E.

The random access procedure can be a four-step random access procedure or a two-step random access procedure, for example. In different implementations and/or scenarios, the random access procedure may be a contention-based random access procedure or a contention-free random access procedure. In some implementations and/or scenarios, the UE 102 may include a UE identifier known by the SN 106A in a “message 3” of a four-step random access procedure, or in a message A of the two-step random access procedure, so that the SN 106A can identify the UE 102 using the UE identifier. In some implementations, the UE identifier is a radio network temporary identifier (RNTI) (e.g., a C-RNTI) allocated by the SN 106A in the first SN configuration, additional SN configuration, or second SN configuration. In other implementations, the SN 106A identifies the UE 102 based on a dedicated random access preamble that the SN 106A receives from the UE 102 during the random access procedure. The SN 106A can allocate the dedicated random access preamble in the second SN configuration.

In some implementations, the SN 106A activates 342E the SCG after or upon performing 352E the random access procedure with the UE 102. For example, the SN 106A can activate 342E the SCG in response to connecting to the UE 102 during the random access procedure. The SN 106A can determine that the UE 102 connects with the SN 106A in response to identifying the UE 102 during the random access procedure (e.g., based on a UE identifier or a dedicated random access preamble that the SN 106A receives from the UE 102 during the random access procedure).

In some implementations, the SN 106A establishes, re-establishes, or resumes the protocol layer(s) and/or entity/entities (e.g., PHY 202A/202B, MAC 204A/204B, and/or RLC 206A/206B) for communication with the UE 102 after activating the SCG. After establishing, re-establishing, or resuming the protocol layer(s) and/or entity/entities, the SN 106A in one implementation transmits downlink transmissions to the UE 102 by the protocol layer(s). After establishing, re-establishing, or resuming the protocol layer(s), the SN 106A in another implementation receives uplink transmissions from the UE 102 by the protocol layer(s). Similarly, the UE 102 in some implementations establishes, re-establishes or resumes the protocol layer(s) (e.g., PHY 202A/202B, MAC 204A/204B, and/or RLC 206A/206B) for communication with the SN 106A after activating the SCG. After establishing, re-establishing, resuming the protocol layer(s), the UE 102 in one implementation transmits uplink transmissions to the SN 106A by the protocol layer(s). After establishing, re-establishing, resuming the protocol layer(s), the UE 102 in another implementation receives downlink transmissions from the SN 106A by the protocol layer(s). The downlink transmissions can include data and/or control signals as described for event 302A, and the uplink transmission can include data and/or control signals described as described for event 302A.

In some implementations, the UE 102 maintains the time alignment timer running in response to deactivating the SCG, so that the UE 102 can determine, when activating the SCG, whether the UE 102 is synchronized with the SN 106A for uplink transmission on the SCG. Similarly, the SN 106A maintains the uplink synchronization timer running in response to deactivating the SCG, so that the SN 106A can determine whether the UE 102 is synchronized with the SN 106A for uplink transmission on the SCG when determining to activate the SCG or generating the second SN configuration.

Example implantations of the second SN configuration are similar to the first SN configuration and/or additional SN configuration. In some implementations, the SN 106A can configure the same or different serving cell(s) (i.e., PSCell and/or zero, one, or more SCells) in the second SN configuration as the first SN configuration or the additional SN configuration. In some implementations, the second SN configuration can be a complete and self-contained configuration (i.e. a full SN configuration). The UE 102 can use the full SN configuration to communicate with the SN 106A without relying on the first SN configuration and/or the additional SN configuration. In other implementations, the SN 106A generates the second SN configuration as a delta SN configuration which augments only a portion of the first SN configuration and/or the additional SN configuration. Accordingly, the UE 102 communicates 354E with the SN 106A using the delta SN configuration and the portion of the first SN configuration and/or the additional SN configuration that is/are not augmented by the delta SN configuration. In yet other implementations, the SN 106A includes only the random access configuration(s) in the second SN configuration so that the UE 102 communicates 354E with the SN 106A using the first SN configuration and/or additional SN configuration.

If the MN 104 is a gNB, the RRC reconfiguration message and the RRC reconfiguration complete message are a RRCReconfiguration message and a RRCReconfigurationComelete message, respectively. If the MN 104 is an eNB or ng-eNB, the RRC reconfiguration message and the RRC reconfiguration complete message are a RRCConnectionReconfiguration message and a RRCConnectionReconfigurationComelete message, respectively.

Referring next to FIG. 3F, in a scenario 300F, the base station 104 operates as an MN and the base station 106A operates as an SN. The scenario 300F is generally similar to the scenario 300E, but with the SN 106A, rather than the MN 104, determining to activate the SCG.

Initially, the UE 102 operates 302F in DC with the MN 104 and the SN 106A. The UE 102 can then perform 390F an SCG deactivation procedure, similar to the SCG deactivation procedure 390A, 391B, 392C, or 393D. After deactivating the SCG during the SCG deactivation procedure 390F, the SN 106A can determine 337F to activate the SCG for communication with the UE 102. In some implementations, the SN 106A can determine that data activity on the SCG exists for the UE 102 and, in response, determine 337F to activate the SCG for communication with the UE 102. In one implementation, if the SN 106A has received data packets to be sent to the UE 102 for the CN 110, the SN 106A can detect that data activity exists for the UE 102.

In other implementations, the MN 104 detects data activity for the UE 102 and sends 333F an Activity Notification message with an active indication for the UE 102 to the SN 106A. The SN 106A determines 337F to activate 337F the SCG for the UE 102 based on the Activity Notification message.

In yet other implementations, the SN 106A determines 337F to activate the SCG for the UE 102 based on a UE preference that the SN 106A receives 335F from the UE 102 via the MN 104. For example, the UE 102 sends 334F UE assistance information (e.g., a UEAssistanceInformation message) to the MN 104 indicating that the UE (temporarily) prefers dual connectivity or has data to transmit on the SCG. The MN 104 can send 335F the UE assistance information to the SN 106A.

In response to the determination 337F, the SN 106A sends 339F to the MN 104 an SN Modification Required message that requests to activate the SCG for the UE 102. In some implementations, the SN 106A includes a second SN configuration in the SN Modification Required message. For example, the SN 106A can include, in the second SN configuration, random access configuration(s) for the UE 102 to perform 352F a random access procedure with the SN 106A as described for event 340E in FIG. 3E. In another example, the SN 106A excludes, in the second SN configuration, random access configuration(s) for the UE 102 as described for event 340E in FIG. 3E. In yet another example, the SN 106A can indicate, in the second SN configuration, whether the UE 102 performs a random access procedure as described for FIG. 3E.

In response to the request to activate the SCG, the MN 104 transmits 344F an RRC reconfiguration message to the UE 102. In response, the UE 102 activates 346F the SCG and transmits 348F an RRC reconfiguration complete message to the MN 104. After receiving 348F the RRC reconfiguration complete message, the MN 104 can send 351F an SN Modification Confirm message to the SN 106A to indicate that the UE 102 has activated the SCG. Alternatively, the MN 104 can send the SN Modification Confirm message to the SN 106A before receiving 348F the RRC reconfiguration complete message.

In some implementations, the SN 106A includes, in the SN Modification Required message the SN 106A transmits 339F, an indication (e.g., a field or an IE) to activate the SCG to cause the MN 104 to transmit 344F the RRC reconfiguration message to activate the SCG. The SN 106A activates 343F the SCG after determining 337F to deactivate the SCG. In some implementations, the SN 106A activates 343F the SCG after receiving 351F the SN Modification Confirm message.

In some implementations, the MN 104 generates an indication (e.g., a field or an IE) to activate the SCG and includes the indication in the RRC reconfiguration message 344F. In other implementations, the SN 106A generates an additional SN configuration including an indication (e.g., a field or an IE) to activate the SCG and includes the additional SN configuration in the SN Modification Required message. The MN 104 can include the additional SN configuration in the RRC reconfiguration message the MN 104 transmits 344F without generating an indication to activate the SCG. The UE 102 activates 346F the SCG in response to the indication received in the RRC reconfiguration message 344F.

Similar to the event 352E, at some point after receiving 344F the RRC reconfiguration message or in response to the RRC reconfiguration message, the UE 102 in some implementations can perform 352F a random access procedure on cell 125A with the SN 106A to activate the SCG with the SN 106A. The UE 102 can perform 352F the random access procedure using one or more random access configurations in the second SN configuration or in the first SN configuration that the UE 102 received before deactivating the SCG.

After activating 346F the SCG and, in some implementations, performing 352F the random access procedure, the UE 102 can communicate 352F data and/or control signals in DC with both the MN 104 and the SN 106A through the cell 124A and the cell 125A, respectively.

The events 333F, 334F, 335F, 337F, 339F, 343F, 344F, 346F, 348F, 351F, 352F, and 354F are collectively referred to in FIG. 3F as an SCG activation procedure 381F.

FIGS. 3E-3F illustrate scenarios in which the MN 104 or the SN 106A determine to activate the SCG. In some scenarios (not shown), the UE 102 can determine to activate the SCG. For example, the UE 102 can determine that the UE 102 has data to transmit to the SN 106A or that the UE 102 prefers to operate in DC. In response to the determination, the UE 102 can activate the SCG and perform a random access procedure with the SN 106A. The UE 102 can then communicate data and/or control signals in DC with both the MN 104 and the SN 106A. In some implementations, if the timer alignment timer is still running at the determination, the UE 102 can skip the random access procedure and directly communicate data and/or control signals in DC with both the MN 104 and the SN 106A.

Next, several example scenarios, in which a base station initiates a conditional PSCell change (CPC) procedure for a UE and deactivates an SCG for the UE, are discussed with reference to FIG. 4A-4E. For convenience, this discussion below may refer to a condition or a configuration in singular, but it will be understood that there may be multiple conditions, and that a conditional configuration can include one or multiple configuration parameters to specify the condition or the multiple conditions. For example, while the discussion may refer to the UE as detecting whether a condition is satisfied, it will be understood that the UE 102 may detect whether multiple conditions are satisfied.

Turning first to FIG. 4A, in a scenario 400A, the base station 104 operates as an MN, and the base station 106A operates as an SN. At the start of the scenario 400A, the UE 102 communicates 402A in DC with the MN 104 in accordance with a first MN configuration, and with the SN 106A in accordance with a first SN configuration, similar to events 302A-E. The SN 106A communicates with the UE 102 via a first PSCell (e.g., cell 125A). The SN 106A then determines 404A that it should generate a C-SN configuration for CPC. The SN 106A can make this determination based on one or more measurement results received from the UE 102 via the MN 104, from the UE directly (e.g., via a signaling radio bearer (SRB) established between the UE 102 and the SN 106A or via a physical control channel), or obtained by the SN 106A from measurements on signals, control channels or data channels received from the UE 102, for example. In some implementations, the SN 106A can detect or estimate that the UE 102 is moving toward coverage of the cell 126A based on uplink signals received from the UE 102 or positioning measurement result(s) received from the UE 102. In response to this determination, the SN 106A generates 404A a C-SN configuration for CPC.

After generating 404A the C-SN configuration, the SN 106A transmits 405A the C-SN configuration to the MN 104, which in turn transmits 407A the C-SN configuration to the UE 102. In some implementations, the SN 106A at event 404A generates a conditional configuration including the C-SN configuration and a trigger condition configuration configuring a condition that the UE 102 detects for connecting to a candidate cell (e.g., C-PSCell 126A), and generates an RRC reconfiguration message including the conditional configuration. The SN 106A then transmits 405A the RRC reconfiguration message to the MN 104. The MN 104 in turn transmits 407A the RRC reconfiguration message to the UE 102. In some implementations, the SN 106A can transmit 405A an SN Modification Acknowledge message including the RRC reconfiguration message to the MN 104 in response to an SN Modification Request message received from the MN 104. In other implementations, the SN 106A can send 405A an SN Modification Required message including the RRC reconfiguration message to the MN 104.

In response to receiving the RRC reconfiguration message at event 407A, the UE 102 can transmit 409A an RRC reconfiguration complete message to the MN 104 which in turn can send 411A the RRC reconfiguration complete message to the SN 106A. In an alternative implementation, the SN 106A can send the RRC reconfiguration message to the UE 102 on an SRB (e.g., SRB3) that the MN 104 or SN 106A configures to exchange RRC messages directly between the UE 102 and the SN 106A. In response to receiving the RRC reconfiguration message, the UE 102 can transmit the RRC reconfiguration complete message to the SN 106A on the SRB. The events 404A, 405A, 407A, and 411A collectively can define a CPC configuration procedure 482A.

To transmit 407A the RRC reconfiguration message, the MN 104 in one implementation transmits an RRC container message including the RRC reconfiguration message to the UE 102 on an SRB (e.g., SRB1). In response, the UE 102 in one implementation transmits 409A the RRC reconfiguration complete message to the MN 104 by transmitting an RRC container response message including the RRC reconfiguration complete message. The MN 104 may send 411A an SN message (e.g., SN Reconfiguration Complete message) including the RRC reconfiguration complete message to the SN 106A after receiving the RRC container response message. After the UE 102 receives 407A the C-SN configuration, the conditional configuration, or the RRC reconfiguration message, the UE 102 can (start to) monitor 416A whether the condition for connecting to the candidate cell 126A is satisfied.

After the CPC configuration procedure 482A, the UE 102, the MN 104 and/or SN 106A perform 490A an SCG deactivation procedure, similar to the SCG deactivation procedure 390A, 391B, 392C, or 393D. The UE 102 retains the C-SN configuration or the conditional configuration in response to or after deactivating the SCG. The UE 102 then continues 418A monitoring whether the condition is satisfied after deactivating the SCG.

After deactivating the SCG, the UE 102 can detect 434A that the condition for connecting to a C-PSCell 126A is satisfied and initiate a random access procedure on the C-PSCell 126A in response to the detection. The UE 102 then performs 436A the random access procedure with the SN 106A via the C-PSCell 126A, e.g., using one or more random access configurations in the C-SN configuration. In some implementations, the UE 102 can transmit a second RRC reconfiguration complete message to the SN 106A via the MN 104 in response to the detection 434A. The MN 104 can forward the second RRC reconfiguration complete message to the SN 106A. In some implementations, the UE 102 can transmit a second RRC container response message (e.g., ULInformationTransferMRDC, RRCConnectionReconfigurationComplete, or an RRCReconfigurationComplete message) including the second RRC reconfiguration complete message to the MN 104. The MN 104 extracts the second RRC reconfiguration complete message and sends an SN message (e.g., an RRC Transfer message or an SN Reconfiguration Complete message) including the second RRC reconfiguration complete message to the SN 106A. Alternatively, in response to the detection 434A, the UE 102 may transmit the second RRC reconfiguration complete message via the C-PSCell 126A on the SRB (e.g., SRB3) during or after the random access configuration to connect to the C-PSCell 126A.

The events 434A and 436A are collectively referred to in this disclosure as a CPC execution procedure 494A.

If the UE 102 successfully completes the random access procedure, the UE 102 operates in DC with the MN 104 and the SN 106A. The UE 102 activates 438A the SCG and communicates 442A data and/or control signals (e.g., as described for event 302A) with the SN 106A via the C-PSCell 126A in accordance with configuration parameters in the C-SN configuration. Alternatively, the UE 102 can activate 438A the SCG in response to or after the detection 434A or transmitting the second RRC reconfiguration complete message. If the SN 106A identifies the UE 102 in the random access procedure 436A, the SN 106A activates 440A the SCG and communicates 442A data and/or control signals (e.g., as described for event 302A) with the UE 102 in accordance with the C-SN configuration. Alternatively, the SN 106A can activate 440A the SCG in response to or after receiving the second RRC reconfiguration complete message.

In some implementations, the random access procedure can be a four-step random access procedure or a two-step random access procedure. In other implementations, the random access procedure can be a contention-based random access procedure or a contention-free random access procedure. In some implementations, if the UE 102 transmits the second RRC reconfiguration complete message to the SN 106A, the UE 102 includes the second RRC reconfiguration complete message in a message 3 of the four-step random access procedure or in a message A of the two-step random access procedure.

With continued reference to FIG. 4A, the C-SN configuration in some implementations can be a complete and self-contained configuration (i.e. a full configuration). The C-SN configuration may include a full configuration indication (an information element (IE) or a field) that identifies the C-SN configuration as a full configuration. The UE 102 in this case can use the C-SN configuration to communicate with the SN 106A without relying on an SN configuration. On the other hand, the C-SN configuration in other cases can include a “delta” configuration, or one or more configurations that augment configuration parameters in a previously received SN configuration (e.g., the first SN configuration). In these cases, the UE 102 can use the delta C-SN configuration together with the previously received SN configuration to communicate 442A with the SN 106A.

The C-SN configuration can include multiple configuration parameters for the UE 102 to apply when communicating with the SN 106A via a C-PSCell 126A. The multiple configuration parameters may configure the C-PSCell 126A and zero, one, or more candidate secondary cells (C-SCells) of the SN 106A to the UE 102. The multiple configuration parameters may configure radio resources for the UE 102 to communicate with the SN 106A via the C-PSCell 126A and zero, one, or more C-SCells of the SN 106A. The multiple configuration parameters may configure zero, one, or more radio bearers. The one or more radio bearers can include an SRB and/or one or more DRBs.

The first SN configuration can include multiple configuration parameters for the UE 102 to communicate with the SN 106A via the PSCell and zero, one, or more secondary cells (SCells) of the SN 106A. The multiple configuration parameters may configure radio resources for the UE 102 to communicate with the SN 106A via the PSCell and zero, one, or more SCells of the SN 106A. The multiple configuration parameters may configure zero, one, or more radio bearers. The one or more radio bearers can include an SRB and/or one or more DRBs.

In some implementations, the C-SN configuration can include a group configuration (CellGroupConfig) IE that configures the C-PSCell 126A and zero, one, or more C-SCells of the SN 106A. In one implementation, the C-SN configuration includes a radio bearer configuration. In another implementation, the C-SN configuration does not include a radio bearer configuration. For example, the radio bearer configuration can be a RadioBearerConfig IE, DRB-ToAddModList IE or SRB-ToAddModList IE, DRB-ToAddMod IE or SRB-ToAddMod IE. In various implementations, the C-SN configuration can be an RRCReconfiguration message, RRCReconfiguration-IEs, or the CellGroupConfig IE conforming to 3GPP TS 38.331. The full configuration indication may be a field or an IE conforming to 3GPP TS 38.331. In other implementations, the C-SN configuration can include an SCG-ConfigPartSCG-r12 IE that configures the C-PSCell 126A and zero, one, or more C-SCells of the SN 106A. In some implementations, the C-SN configuration is an RRCConnectionReconfiguration message, RRCConnectionReconfiguration-IEs, or the ConfigPartSCG-r12 IE conforming to 3GPP TS 36.331. The full configuration indication may be a field or an IE conforming to 3GPP TS 36.331.

In some implementations, the SN configuration can include a CellGroupConfig IE that configures the PSCell and may configure zero, one, or more SCells of the SN 106A. In one implementation, the SN configuration can be an RRCReconfiguration message, RRCReconfiguration-IEs or the CellGroupConfig IE conforming to 3GPP TS 38.331. In other implementations, the SN configuration can include an SCG-ConfigPartSCG-r12 IE that configures the PSCell and may configure zero, one, or more SCells of the SN 106A. In one implementation, the SN configuration can be an RRCConnectionReconfiguration message, RRCConnectionReconfiguration-IEs or the ConfigPartSCG-r12 IE conforming to 3GPP TS 36.331.

In some cases, the UE 102 may receive one or more conditions (discussed in this disclosure in singular for convenience) in the trigger condition configuration (e.g., condExecutionCond-r16 field) in the RRC reconfiguration at event 407A. The UE 102 may monitor for the one or more conditions to determine whether to connect to the C-PSCell 126A. If the UE 102 detects 434A that the condition is satisfied, the UE 102 connects to the C-PSCell 126A. That is, the condition (or “triggering condition”) triggers the UE 102 to connect to the C-PSCell 126A or to execute (i.e., to apply) the C-SN configuration. However, if the UE 102 does not detect that the condition is satisfied, the UE 102 does not connect to the C-PSCell 126A. As used in this disclosure, “applying a conditional configuration” can include connecting to a candidate cell in accordance with the conditional configuration.

In some implementations, the conditional configuration can be an IE (e.g., CondReconfigToAddMod-r16 IE). In some implementations, the SN 106A can generate a field (e.g., condRRCReconfig-r16 field) to include or identify the C-SN configuration and include the field in the conditional configuration or RRC reconfiguration message at event 405A. In some implementations, the SN 106A can generate a field (e.g., condExecutionCond-r16 field) to include or identify the trigger condition configuration and include the field in the conditional configuration or RRC reconfiguration message at event 405A.

When the SN 106A is implemented as an ng-eNB, the RRC reconfiguration message is an RRCConnectionReconfiguration message, and the RRC reconfiguration complete message is RRCConnectionReconfigurationComplete. When the SN 106A is implemented as a gNB, the RRC reconfiguration message is an RRCReconfiguration message, and the RRC reconfiguration complete message is an RRCReconfigurationComplete message. When the MN 104 is implemented as an eNB or ng-eNB, the RRC container message is an RRCConnectionReconfiguration message, and the RRC container response message is RRCConnectionReconfigurationComplete. When the MN 104 is implemented as a gNB, the RRC container message is an RRCReconfiguration message, and the RRC container response message is an RRCReconfigurationComplete message.

Referring next to FIG. 4B, in a scenario 400B, the base station 104 operates as an MN, and the base station 106A operates as an SN. The scenario 400B is generally similar to the scenario 400A, but with the SCG remaining deactivated after the UE 102 connects to the C-PSCell. In particular, the events 402B, 482B, 416B, 490B, 418B, and 494B are similar to the events 402A, 482A, 416A, 490A, 418A, and 494A, respectively. However, after performing 494B the CPC execution procedure, neither the UE 102 nor the SN 106A reactivates the SCG. Rather, the UE 102 refrains 439B from reactivating the SCG and the SN 106A refrains 441B from reactivating the SCG.

Referring next to FIG. 4C, in a scenario 400C, the base station 104 operates as an MN and the base station 106A operates as an SN. The scenario 400C is initially similar to the scenario 400A, but the UE 102 does not connect to the C-PSCell while the SCG is deactivated.

The events 402C, 482C, 416C, and 490C are similar to the events 402A, 482A, 416A, and 490A. In contrast to the scenarios 400A and 400B, the UE 102 does not connect to the C-PSCell while the SCG is deactivated. In some implementations, the UE 102 stops 419C monitoring whether the condition is satisfied. In other implementations, the UE 102 continues to monitor for whether the condition is satisfied, but refrains 419C from connecting to the C-PSCell if the UE 102 detects that the condition is satisfied. Both possible actions at event 419C prevent the UE 102 from connecting to the C-PSCell while the SCG is deactivated.

At a later time, the UE 102 and the SN 106A may reactivate the SCG via an SCG activation procedure 480C, which may be similar to the SCG activation procedure 380E or 381F. In response to activating the SCG, the UE 102 can allow connection to the C-PSCell. If the UE 102 stopped 419C monitoring for the condition, the UE 102 can start 420C monitoring whether the condition is satisfied after the SCG activation procedure 480C or when the UE 102 determines to transmit to the SN 106A or receive data via the SCG. If the UE 102 refrained 419C from connecting to the C-PSCell if the UE 102 detected the condition, the UE 102 can allow 420C connecting to the C-PSCell if the UE 102 detects that the condition is satisfied.

If the UE 102 detects that the condition is satisfied, the UE 102 can perform a CPC execution procedure 494C, which is similar to the CPC execution procedure 494A, and can operate 442C in DC with the MN 104 and the SN 106A via the C-PSCell in accordance with the C-SN configuration.

Referring next to FIG. 4D, in a scenario 400D, the base station 104 operates as an MN, and the base station 106A operates as an SN. The scenario 400D is initially similar to the scenario 400A, but the UE 102 releases the C-SN configuration after deactivating the SCG.

The events 402D, 482D, 416D, and 490D are similar to the events 402A, 482A, 416A, and 490A. However, after performing 490D the SCG deactivation procedure, the UE 102 releases 422D the C-SN configuration. Likewise, the SN 106A releases 424A the C-SN configuration after performing the SCG deactivation procedure 490D. “Releasing” the C-SN configuration can refer to releasing the C-SN configuration and/or the trigger condition configuration.

In some implementations, the UE 102 releases 422D the C-SN configuration in response to or after deactivating the SCG during the SCG deactivation procedure 490D. That is, the UE 102 can release 422D the C-SN configuration independently from the MN 104 and the SN 106A. In other implementations, the SN 106A and/or the MN 104 can perform a CPC configuration procedure 484D to indicate that the UE 102 should release the C-SN configuration or to command the UE 102 to release the C-SN configuration. The CPC configuration procedure 484D can be similar to the CPC configuration procedure 482A, except that the RRC reconfiguration message that the SN 106A transmits to the MN 104, and which the MN 104 in turn transmits to the UE 102, instructs the UE 102 to release the C-SN configuration.

Referring next to FIG. 4E, in a scenario 400E, the base station 104 operates as an MN, and the base station 106A operates as an SN. The scenario 400E is initially similar to the scenario 400A, but the UE 102 updates the conditional configuration after deactivating the SCG.

The events 402E, 482E, 416E, and 490E are similar to the events 402A, 482A, 416A, and 490A, respectively. After performing 490E the SCG deactivation procedure, the SN 106A performs a CPC configuration procedure 484E to instruct the UE 102 to update the conditional configuration. The CPC configuration procedure 484E is similar to the CPC configuration procedure 484D. However, the SN 106A generates a second conditional configuration (which can be second conditional configuration parameters that augment the conditional configuration). The second conditional configuration can include a second C-SN configuration, and may also include a second trigger condition configuration associated with the second C-SN configuration. Alternatively, the second conditional configuration can include a second trigger condition configuration associated with the earlier C-SN configuration (i.e., the second conditional configuration can include an update to the trigger condition configuration for the C-SN configuration).

In some implementations, the SN 106A generates a second conditional configuration that the UE 102 is unlikely to apply or that the UE 102 cannot apply, thereby preventing the UE 102 from connecting to the C-PSCell while the SCG is deactivated. As one example, the second trigger condition configuration can include one or more trigger conditions that are unlikely to occur or that cannot occur (e.g., the SN 106A can utilize a high threshold for a measurement result). As another example, the second C-SN configuration can be for a cell that the UE 102 is not moving towards or a cell for which the UE 102 is not within the coverage area.

The SN 106A generates the second conditional configuration and transmits the second conditional configuration to the UE 102 via the MN 104 during the CPC configuration procedure 484E. The UE 102 can then update 421E the conditional configuration to the second conditional configuration (e.g., by updating the C-SN configuration to the second C-SN configuration and/or the trigger condition configuration to the second trigger condition configuration). Similarly, the SN 106A also updates 423E the conditional configuration at the SN 106A.

Next, several example scenarios, in which a base station initiates a conditional SN addition or change (CSAC) procedure for a UE and deactivates an SCG for the UE, are discussed with reference to FIG. 5A-5E. FIGS. 5A-5E are example message sequences similar to FIGS. 4A-4E, but with the base station initiating a CSAC procedure rather than a CPC procedure. Accordingly, events in the scenarios depicted in FIGS. 5A-5B similar to those discussed with respect to FIGS. 4A-4E are labeled with similar reference numbers. With the exception of the differences shown in the figures and the differences described below, any of the alternative implementations discussed above with respect to the scenarios 400A-E (e.g., for messaging and processing) may apply to the scenarios 500A-E, respectively.

Referring first to FIG. 5A, in a scenario 500A, the base station 104 operates as an MN, the base station 106B operates as an SN, and the base station 106A operates as a C-SN. Initially, the UE 102 initially operates 502A in DC with the MN 104 and the SN 106B in accordance with a first SN configuration, similar to event 302A.

The MN 104 at some point determines 504A to configure the base station 106A as a C-SN for the purposes of a CSAC procedure (i.e., configure cell 126A as a candidate cell for the UE 102), to allow the UE 102 to start using the C-SN 106A instead of the SN 106B when the UE 102 detects that the corresponding condition is satisfied. The MN 104 may make the determination 504A based on one or more measurement results received from the UE 102, or in response to receiving a message indicating that a conditional SN change is required (e.g., an SN Change Required message), for example. In some implementations, the MN 104 or SN 106B can detect or estimate that the UE 102 is moving toward coverage of the cell 126A based on uplink signals received from the UE 102 or positioning measurement result(s) received from the UE 102. In response to the determination 504A, the MN 104 can send 506A an SN Request message to the C-SN 106A to initiate the CSAC. In some implementations, the MN 104 can indicate in the SN Request message that the MN 104 requests the base station 106A to be a C-SN for the UE 102. In response to the SN Request message, the C-SN 106A can generate 508A a C-SN configuration for a C-PSCell (e.g., cell 126A), for the CSAC.

The C-SN 106A can send 510A the MN 104 an SN Request Acknowledge message that includes the C-SN configuration, in response to the SN Request message. The C-SN configuration can configure a C-PSCell and also may configure zero, one, or more C-SCells. The MN 104 may then include the C-SN configuration in a conditional configuration, and send 512A an RRC container message including the conditional configuration to the UE 102. In some implementations, the UE 102 sends 514A an RRC container response message to the MN 104 in response to the RRC container message. In some implementations, the MN 104 sends an SN Reconfiguration Complete message (not shown in FIG. 5A) to the C-SN 106A in response to receiving 514A the RRC container response message. In other implementations, and as shown in FIG. 5A, the MN 104 does not send the SN Reconfiguration Complete message to the C-SN 106A. Events 504A, 506A, 508A, 510A, 512A, and 514A are collectively referred to as a CSAC configuration procedure 584A.

In some implementations, the SN Request message at event 506A is an SN Addition Request, and the SN Request Acknowledge message is be an SN Addition Request Acknowledge message. In other implementations, the SN Request message is an SN Modification Request, and the SN Request Acknowledge message is an SN Modification Request Acknowledge message.

In some implementations, the MN 104 includes the C-SN configuration in an RRC reconfiguration message, includes the RRC reconfiguration message in the conditional configuration, and includes the conditional configuration in the RRC container message that the MN 104 sends 512A to the UE 102. In some implementations, the MN 104 includes, in the conditional configuration, a trigger condition configuration configuring a condition that the UE 102 detects for connecting to a candidate cell (e.g., C-PSCell 126A). The MN 104 may generate the trigger condition configuration by itself or receive the trigger condition configuration from the SN 106B. If the MN 104 is implemented as a gNB, the RRC container message and RRC reconfiguration message can be RRCReconfiguration messages. If the MN 104 is instead implemented as an eNB or a ng-eNB, the RRC container message and RRC reconfiguration message can be RRCConnectionReconfiguration messages. After the UE 102 receives 512A the conditional configuration or the RRC container message, the UE 102 can (start to) monitor 516A whether the condition for connecting to the candidate cell 126A is satisfied.

After the CSAC configuration procedure 584A, the UE 102, the MN 104 and/or SN 106B perform 590A an SCG deactivation procedure, similar to the SCG deactivation procedure 390A, 391B, 392C, or 393D. The UE 102 continues 518A monitoring whether the condition is satisfied after deactivating the SCG, similar to event 418A. More specifically, the UE 102 retains the C-SN configuration or the conditional configuration in response to or after deactivating the SCG.

After deactivating the SCG, the UE 102 can detect 534A that the condition for connecting to a C-PSCell 126A is satisfied and initiate a random access procedure on the C-PSCell 126A in response to the detection, similar to event 434A. The UE 102 then performs 536A the random access procedure with the C-SN 106A via the C-PSCell 126A, e.g., using one or more random access configurations in the C-SN configuration, activates 538A the SCG (which can be a new SCG configured in the C-SN configuration by the C-SN 106A), and communicates 542A data and/or control signals with the C-SN 106A via the C-PSCell 126A using the C-SN configuration, similar to event 436A, 438A and 442A respectively. Similarly, the C-SN 106A activates 540A the SCG and communicates 542A data and/or control signals with the UE 102 via the C-PSCell 126A, similar to the event 440A and 442A respectively.

In some implementations, the UE 102 can transmit a second RRC container response message to the MN 104 in response to the detection 534A. Thus, the MN 104 can determine that the UE 102 connects to the C-SN 106A upon receiving the second RRC container response message. In some implementations, the UE 102 can include a second RRC reconfiguration complete message in the second RRC container response message. In such implementations, the MN 104 can send to the C-SN 106A a second SN message (e.g., RRC Transfer message or SN Reconfiguration Complete message) including the second RRC reconfiguration complete message. In some implementations, the UE 102 can indicate in the second RRC reconfiguration complete message that the UE 102 prefers to deactivate the SCG.

If the MN 104 is implemented as a gNB, the RRC container response message 514A and second RRC container response message can be RRCReconfigurationComplete messages. If the MN 104 is instead implemented as an eNB or an ng-eNB, the RRC container response message 514A and second RRC container response message can be RRCConnectionReconfigurationComplete messages.

The events 534A and 596A are collectively referred to in this disclosure as a CSAC execution procedure 596A.

Referring next to FIG. 5B, in a scenario 500B, the base station 104 operates as an MN, the base station 106B operates as an SN, and the base station 106A operates as a C-SN. The scenario 500B is generally similar to the scenario 500A, but with the SCG remaining deactivated after the UE connects to the C-SN. Further, the scenario 500B is also generally similar to the scenario 400B, but with the UE 102 receiving a conditional configuration associated with a CSAC procedure rather than a CPC procedure. Accordingly, events 502B, 584B, 516B, 590B, 518B, and 596B are similar to the events 502A, 584A, 516A, 590A, 518A, and 596A, respectively. However, after performing 596B the CSAC execution procedure, neither the UE 102 nor the C-SN 106A reactivates the SCG. Rather, the UE 102 refrains 539B from reactivating the SCG, and the C-SN 106A also refrains 541B from reactivating the SCG. Alternatively, the C-SN 106A deactivates 541B the SCG.

In some implementations, during or after the SCG deactivation procedure, the MN 104 can send to the C-SN 106A a second SN Request message to indicate that the UE 102 deactivates the SCG. Thus, when the C-SN 106A identifies the UE 102 in the random access procedure, the C-SN 106A refrains 541B from reactivating the SCG or deactivates 541B the SCG in response to the identification of the UE 102. In other implementations, during the CSAC execution procedure, the MN 104 can indicate the C-SN 106A to deactivate the SCG. In response to the indication, the C-SN 106A refrains 541B from reactivating the SCG or deactivates 541B the SCG. For example, the MN 104 can include an indication to indicate the C-SN 106A to deactivate the SCG in the second SN message in the CSAC execution procedure described for FIG. 5A.

Referring next to FIG. 5C, in a scenario 500C, the base station 104 operates as an MN, the base station 106B operates as an SN, and the base station 106A operates as a C-SN. The scenario 500C is initially similar to the scenario 500A, but the UE 102 does not connect to the C-SN 106A while the SCG is deactivated. The scenario 500C is also similar to the scenario 400C, but with the UE 102 receiving a conditional configuration associated with a CSAC procedure rather than a CPC procedure. Accordingly, events 502C, 584C, 516C, and 590C are similar to the events 502A, 584A, 516A, 590A, 518A, and 596A, respectively.

In contrast to the scenarios 500A and 500B, the UE 102 does not connect to the C-SN 106A while the SCG is deactivated. In some implementations, the UE 102 stops 519C monitoring whether the condition is satisfied. In other implementations, the UE 102 continues to monitor whether the condition is satisfied, but refrains 519C from connecting to the C-PSCell of the C-SN 106B while the SCG is deactivated. Similar to the event 419C, both possible actions at event 519C prevent the UE 102 from connecting to the C-PSCell of the C-SN 106A while the SCG is deactivated.

At a later time, the UE 102 and the SN 106B may reactivate the SCG via an SCG activation procedure 580C, which may be similar to the SCG activation procedure 380E or 381F. Similar to the event 420C, in response to activating the SCG, the UE 102 can allow connection to the C-PSCell of the C-SN 106A. If the UE 102 stopped 519C monitoring for the condition, the UE 102 can start 520C monitoring whether the condition is satisfied after the SCG activation procedure 580C or when the UE 102 determines to transmit to the SN 106A or receive data via the SCG. If the UE 102 refrained 519C from connecting to the C-PSCell if the UE 102 detected the condition, the UE 102 can allow 520C connecting to the C-PSCell if the UE 102 detects that the condition is satisfied.

If the UE 102 detects that the condition is satisfied, the UE 102 can perform a CSAC execution procedure 596C, which is similar to the CSAC execution procedure 596A, and can operate 542C in DC with the MN 104 and the C-SN 106A via the C-PSCell in accordance with the C-SN configuration.

Referring next to FIG. 5D, in a scenario 500D, the base station 104 operates as an MN, the base station 106B operates as an SN, and the base station 106A operates as a C-SN. The scenario 500D is initially similar to the scenario 500A, but the UE 102 releases the C-SN configuration after deactivating the SCG. Further, the scenario 500D is also similar to the scenario 400D, except that the UE 102 receives a conditional configuration associated with a CSAC procedure rather than a CPC procedure.

The events 502D, 584D, 516D, and 590D are similar to the events 502A, 584A, 516A, and 590A. However, after performing 590D the SCG deactivation procedure, the UE 102 releases 562D the C-SN configuration, similar to the event 422D. Further, the MN 104 determines 552D to release the C-SN configuration in response to the SCG deactivation. “Releasing” the C-SN configuration can refer to releasing the C-SN configuration and/or the trigger condition configuration.

In some implementations, the UE 102 releases 562D the C-SN configuration in response to or after deactivating the SCG during SCG deactivation procedure 590D. That is, the UE 102 can release 562D the C-SN configuration independently from the MN 104. In other implementations, the MN 104 can, after determining 552D to release the C-SN configuration, transmit 554D a message to the UE 102 instructing the UE 102 to release the C-SN configuration. The message can be an RRC reconfiguration message including an indication to release the conditional configuration, for example. In response, the UE 102 can transmit 556D a RRC reconfiguration complete message to the MN 104. If the MN 104 is implemented as a gNB, the RRC reconfiguration message and RRC reconfiguration complete message can be a RRCReconfiguration and a RRCReconfigurationComplete message, respectively. If the MN 104 is instead implemented as an eNB or an ng-eNB, the RRC reconfiguration message and RRC reconfiguration complete message can be a RRCConnectionReconfiguration and a RRCConnectionReconfigurationComplete message, respectively.

After determining 552D to release the C-SN configuration, the MN 104 transmits 558D an SN Release Request message to the C-SN 106A to instruct the C-SN 106A to release the C-SN. In response, the C-SN 106A can transmit 560D an SN Release Request Acknowledge message to the MN 104 and release 564D the C-SN configuration.

Referring next to FIG. 5E, in a scenario 500E, the base station 104 operates as an MN, the base station 106B operates as an SN, and the base station 106A operates as a C-SN. The scenario 500E is initially similar to the scenario 500A, but the UE 102 updates the conditional configuration after deactivating the SCG. Further, the scenario 500E is also similar to the scenario 400E, except that the UE 102 receives a conditional configuration associated with a CSAC procedure rather than a CPC procedure.

The events 502E, 584E, 516E, and 590E are similar to the events 502A, 584A, 516A, and 590A, respectively. In response to the SCG deactivation, the MN 104 determines 553E to update the conditional configuration to prevent the UE from performing a CSAC execution procedure (i.e., to prevent the UE 102 from connecting to the C-SN 106A via the C-PSCell or from applying the C-SN configuration). The MN 104 transmits 555E an indication to the UE 102 to update the conditional configuration. The indication can be included in an RRC reconfiguration message, and the UE 102 can send 556E an RRC reconfiguration complete message to the MN 104 in response. The indication can include a second conditional configuration (which can be second conditional configuration parameters that augment the conditional configuration for the C-SN). The second conditional configuration can include a second C-SN configuration, and may also include a second trigger condition configuration associated with the second C-SN configuration. Alternatively, the second conditional configuration can include a second trigger condition configuration associated with the earlier C-SN configuration (i.e., the second conditional configuration can include an update to the trigger condition configuration for the C-SN configuration). In some implementations, the MN 104 can perform a second CSAC configuration procedure to obtain the second C-SN configuration and/or the second trigger condition configuration from the C-SN 106A, similar to the CSAC configuration procedure 584E. The MN 104 can include an indication to instruct the C-SN 106A to update the conditional configuration to prevent the UE from performing a CSAC execution procedure. In other implementations, the MN 104 can generate the second C-SN configuration and/or the second trigger condition configuration by itself.

The second conditional configuration can be a configuration that the UE 102 is unlikely to apply or that the UE 102 cannot apply, thereby preventing the UE 102 from connecting to the C-SN 106A while the SCG is deactivated. As one example, the second trigger condition configuration can include one or more trigger conditions that are unlikely to occur or that cannot occur. As another example, the second C-SN configuration can be for a cell or a C-SN that the UE 102 is not moving towards or a cell for which the UE 102 is not within the coverage area.

The UE 102 receives 555E the indication to update the conditional configuration, and updates 563E the conditional configuration in response. For example, if the indication includes a second conditional configuration, the UE 102 updates 563E the conditional configuration to the second conditional configuration. Similarly, the MN 104 also updates 565E the conditional configuration.

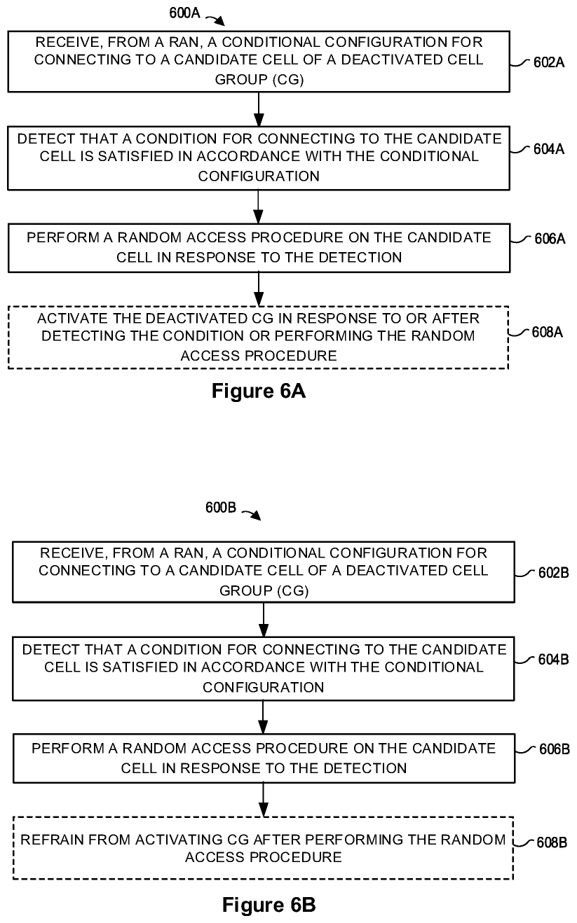

FIGS. 6A-12 are flow diagrams depicting example methods that a UE (e.g., the UE 102) or a RAN (e.g., the RAN 105) can perform for managing conditional configurations during SCG deactivation.

FIG. 6A is a flow diagram of an example method 600A, which can be implemented by a UE (e.g., the UE 102). Initially, at block 602A, the UE receives, from a RAN (e.g., the RAN 105) a conditional configuration for connecting to a candidate cell (e.g., a C-PSCell) of a deactivated cell group (CG). For example, the CG can be an SCG and the UE can communicate with an MN while the SCG is deactivated. The UE can receive the conditional configuration from the MN or the SN prior to deactivating the SCG (e.g., event 407A or 512A, or similar events within procedures 482B-E or 584B-E), or from the MN after deactivating the SCG, for example.

At block 604A, the UE detects that a condition for connecting to the candidate cell is satisfied in accordance with the conditional configuration (e.g., event 434A or 534A, or similar events within procedure 494B or 596B). At block 606A, the UE performs a random access procedure on the candidate cell in response to the detection (e.g., event 436A or 536A, or similar events within procedure 494B or 596B). Next, at block 608A, the UE activates the deactivated CG (e.g., the deactivated SCG) in response to or after detecting the condition, or in response to or after performing the random access procedure (e.g., event 438A or 538A).

FIG. 6B is a flow diagram of an example method 600B, which can be implemented by a UE (e.g., the UE 102). Blocks 602B, 604B, and 606B are similar to the blocks 602A, 604A, and 606A, respectively. However, at block 608B, the UE refrains from activating the CG after performing the random access procedure (e.g., event 439B or 539B).

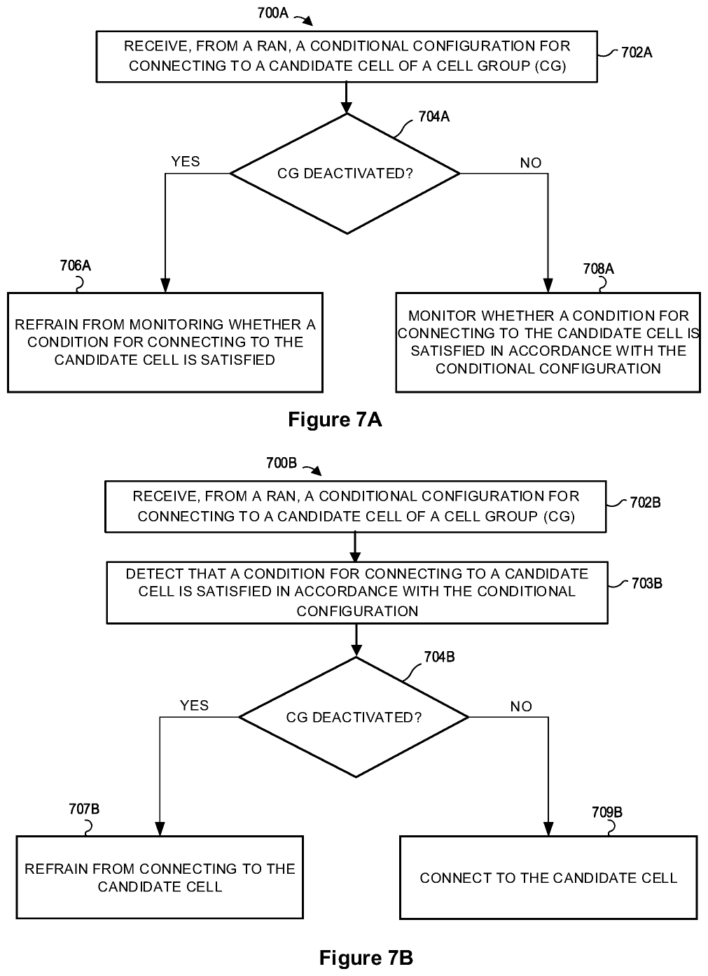

FIG. 7A is a flow diagram of an example method 700A, which can be implemented in a UE (e.g., the UE 102). At block 702A, the UE receives, from a RAN (e.g., the RAN 105) a conditional configuration for connecting to a candidate cell of a CG. At block 704A, the UE determines whether the CG is deactivated. If the CG is deactivated, at block 706A, the UE refrains from monitoring whether a condition for connecting to the candidate cell is satisfied (e.g., event 419C or 519C). If the CG is not deactivated, at block 708A, the UE monitors whether a condition for connecting to the candidate cell is satisfied in accordance with the conditional configuration (e.g., event 420C or 520C).

FIG. 7B is a flow diagram of an example method 700B, which can be implemented in a UE (e.g., the UE 102). At block 702B, the UE, receives, from a RAN (e.g., the RAN 105) a conditional configuration for connecting to a candidate cell of a CG. At block 703B, the UE detects that a condition for connecting to a candidate cell is satisfied in accordance with the conditional configuration. At block 704B, the UE determines whether the CG is deactivated. If the CG is deactivated, at block 707B, the UE refrains from connecting to the candidate cell (e.g., event 419C or 519C). If the CG is not deactivated, at block 709B, the UE connects to the candidate cell (e.g., event 420C or 520C).

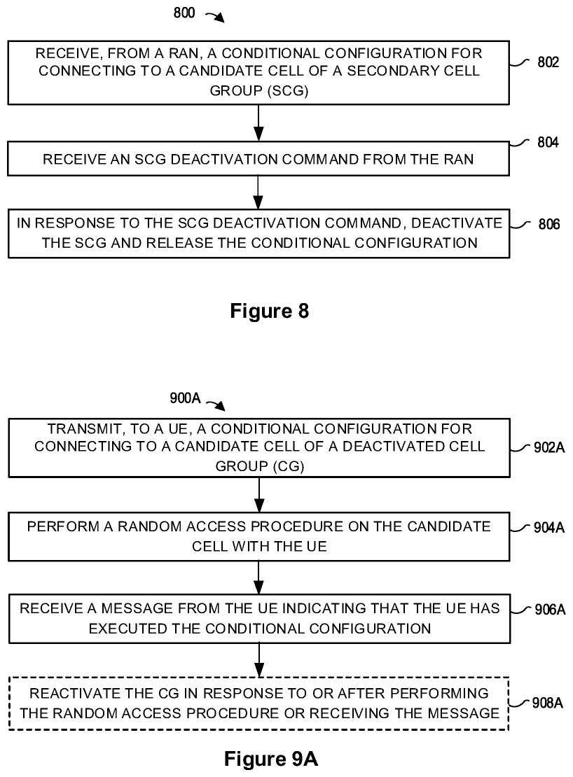

FIG. 8 is a flow diagram of an example method 800, which can be implemented in a UE (e.g., the UE 102). At block 802, the UE receives, from a RAN (e.g., the RAN 105) a conditional configuration for connecting to a candidate cell of an SCG (e.g., event 407A or 512A, or similar events within procedures 482B-E or 584B-E). At block 804, the UE receives an SCG deactivation command from the RAN (e.g., event 314A, 314B, 315C, or similar events within procedures 490A-E or 590A-E). At block 806, in response to the SCG deactivation command, the UE deactivates the SCG (e.g., event 316A, 316B, or 316C, or similar events within procedures 490A-E or 590A-E) and releases the conditional configuration (e.g., event 422D or 562D). In some implementations, the UE may deactivate the SCG without receiving an SCG deactivation command (e.g., event 316D) and release the conditional configuration in response to deactivating the SCG.

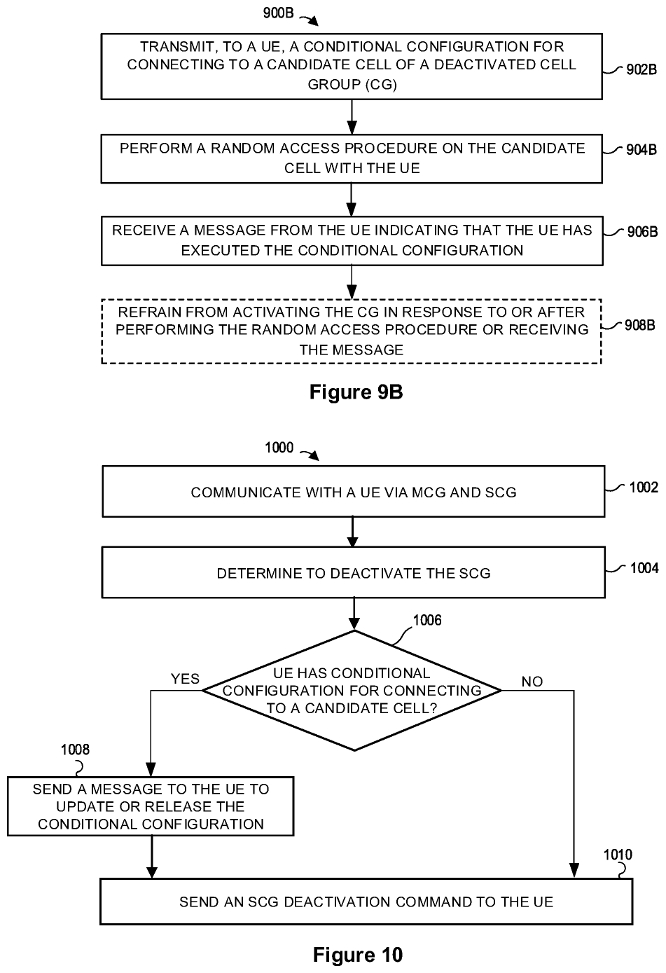

FIG. 9A is a flow diagram of an example method 900A, which can be implemented by a RAN (e.g., the RAN 105). At block 902A, the RAN transmits, to a UE (e.g., the UE 102), a conditional configuration for connecting to a candidate cell (e.g., a C-PSCell) of a deactivated CG. For example, the CG can be an SCG and the UE can communicate with an MN of the RAN while the SCG is deactivated. The MN or the SN can transmit the conditional configuration to the UE prior to the SCG deactivation (e.g., event 407A or 512A, or similar events within procedures 482B-E or 584B-E), or MN can transmit the conditional configuration to the UE after the SCG deactivation, for example.

At block 904A, the RAN performs a random access procedure on the candidate cell with the UE (e.g., event 436A or 536A, or similar events within procedure 494B or 596B). At block 906A, the RAN receives a message from the UE indicating that the UE has executed or applied the conditional configuration. The message can be an RRC reconfiguration complete message, such as the second RRC reconfiguration complete message discussed with reference to event 436A. In some implementations, the UE can include the RRC reconfiguration complete message in an RRC container response message (e.g., a ULInformationTransferMRDC).

At block 908A, in response to or after performing the random access procedure, or in response to or after receiving the message, the RAN reactivates the SCG (e.g., event 440A or 540A).

FIG. 9B is a flow diagram of an example method 900A, which can be implemented by a RAN (e.g., the RAN 105). Blocks 902B, 904B, and 906B are similar to the blocks 902A, 904A, and 906A, respectively. However, at block 908B, the RAN refrains from activating the CG in response to or after performing the random access procedure or receiving the message (e.g., event 441B or 541B).

FIG. 10 is a flow diagram of an example method 1000, which can be implemented by a RAN (e.g., the RAN 105). At block 1002, the RAN communicates with a UE (e.g., the UE 102) via an MCG (e.g., event 302A-F, 402A-E, or 502A-E). At block 1004, the RAN determines to deactivate the SCG (e.g., event 308A, 307B, 307C, or similar events within procedures 490A-E or 590A-E).

At block 1006, the RAN determines whether the UE has a conditional configuration for connecting to a candidate cell (e.g., a conditional configuration associated with a CPC procedure or a CSAC procedure, as discussed with reference to FIGS. 4A-4E and 5A-5E, respectively). If the UE has a conditional configuration (e.g., because the RAN previously transmitted a conditional configuration to the UE), then the UE, at block 1008, sends a message to the UE to update or to release the conditional configuration (e.g., event 554D or 555E, or events during procedure 484D or 484E).

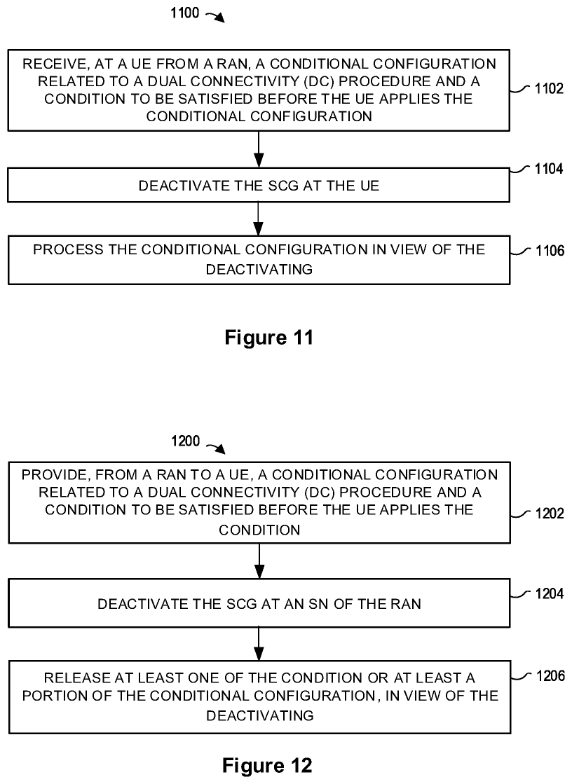

FIG. 11 is a flow diagram of an example method 1100 for managing a conditional configuration during SCG deactivation, which can be implemented by a UE (e.g., the UE 102) communicating in DC with a RAN (e.g., the RAN 105) via an MN and an SN. At block 1102, the UE receives, from the RAN, a conditional configuration related to a DC procedure (e.g., CSAC or CPC) and a condition to be satisfied before the UE applies the conditional configuration (e.g., event 407A or 512A, or similar events within procedures 482B-E or 584B-E). At block 1104, the UE deactivates the SCG at the UE (e.g., events 316A-D or similar events within procedures 490A-E or 590A-E). As discussed with reference to FIGS. 3A-3F, the MN, the SN, or the UE can initiate deactivating and/or reactivating the SCG.

At block 1106, the UE processes the conditional configuration in view of the deactivating. In some implementations, the UE releases the conditional configuration (e.g., event 422D or 562D). In other implementations, the UE retains the conditional configuration. If the UE retains the conditional configuration, the UE can monitor whether the condition is satisfied (e.g., event 418A-B, 518A-B) or stop monitoring whether the condition is satisfied (e.g., event 419C, 519C). If the UE monitors whether the condition is satisfied and detects that the condition is satisfied, the UE can apply the conditional configuration (i.e., connect to a candidate cell in accordance with the conditional configuration) and reactivate the SCG (e.g., event 438A, 538A), apply the conditional configuration and refrain from reactivating the SCG (e.g., event 439B. 539B), or refrain from applying the conditional configuration (e.g., event 419C, 519C). If the UE retains the conditional configuration, the UE may receive an instruction from the RAN to release or update the configuration and/or the condition (e.g., event 554D or 555E, or events during procedure 484D or 484E).

FIG. 12 is a flow diagram of an example method 1200 for managing a conditional configuration during SCG deactivation, which can be implemented by a RAN (e.g., the RAN 105) communicating with a UE (e.g., the UE 102) in DC. At block 1202, the RAN provides to the UE a conditional configuration related to a DC procedure and a condition to be satisfied before the UE applies the conditional configuration (e.g., event 407A or 512A, or similar events within procedures 482B-E or 584B-E). At block 1204, the RAN deactivates the SCG at an SN of the RAN (e.g., events 322A-D or similar events within procedures 490A-E or 590A-E).

At block 1206, the RAN releases at least one of the condition or at least a portion of the conditional configuration in view of the deactivating. In some implementations, the RAN releases the conditional configuration and/or the condition (e.g., events 424D, 552D, 564D). The RAN can transmit an indication to the UE instructing the UE to release the conditional configuration and/or the condition (e.g., event 554D or during procedure 484D). In other implementations, the RAN updates the conditional configuration and/or the condition (e.g., event 423E or 565E). To update the conditional configuration, the RAN releases at least a portion of the conditional configuration and replaces the released portion of the conditional configuration with new parameters. To update the condition, the RAN releases the condition and replaces the condition with a new condition. The RAN can send an indication to the UE instructing the UE to update the conditional configuration and/or the condition (e.g., event 555E or during procedure 484E).

The following list of examples reflects a variety of the embodiments explicitly contemplated by the present disclosure:
Example 1. A method in a user equipment (UE), communicating in dual connectivity (DC) with a radio access network (RAN) via a master node (MN) and a secondary node (SN), for managing a conditional configuration during deactivation of a secondary cell group (SCG), the method comprising: receiving, by a processing hardware of the UE and from the RAN, the conditional configuration related to a DC procedure and a condition to be satisfied before the UE applies the conditional configuration; deactivating, by the processing hardware, the SCG at the UE; processing, by the processing hardware, the conditional configuration in view of the deactivating.
Example 2. The method of example 1, wherein the processing includes: releasing the conditional configuration.
Example 3. The method of example 1, wherein the processing includes: retaining the conditional configuration.
Example 4. The method of example 3, wherein the processing further includes: monitoring whether the condition is satisfied.
Example 5. The method of example 4, wherein the processing further includes: detecting that the condition is satisfied; and in response to the detecting, applying the conditional configuration.
Example 6. The method of example 5, wherein the method further comprises: in response to the detecting, reactivating, by the processing hardware, the SCG at the UE.
Example 7. The method of example 4, wherein the processing further includes: detecting that the condition is satisfied; and in response to the detecting, preventing the UE from applying the conditional configuration.
Example 8. The method of example 7, further comprising: reactivating, by the processing hardware, the SCG after the deactivating; and in response to the reactivating, applying, by the processing hardware, the conditional configuration if the UE detects that the condition is satisfied.
Example 9. The method of any one of examples 5-8, wherein applying the conditional configuration includes connecting to a candidate cell of the RAN in accordance with the conditional configuration.
Example 10. The method of example 3, wherein the processing further includes: preventing the UE from monitoring whether the condition is satisfied.
Example 11. The method of example 10, further comprising: reactivating, by the processing hardware, the SCG after the deactivating; and in response to the reactivating, monitoring, by the processing hardware, whether the condition is satisfied.
Example 12. The method of example 3, wherein the method further comprises: receiving, by the processing hardware and from the RAN, after deactivating the SCG, an indication instructing the UE to release the conditional configuration; and releasing, by the processing hardware, the conditional configuration in response to receiving the indication.
Example 13. The method of example 3, wherein the method further comprises: receiving, by the processing hardware and from the RAN, at least one of a new conditional configuration related to the DC procedure or a new condition; and replacing, by the processing hardware, at least one of the conditional configuration or the condition with the new conditional configuration or the new condition, respectively.
Example 14. The method of any one of the preceding examples, wherein the DC procedure is a conditional SN addition or change (CSAC) procedure.
Example 15. The method of any one of examples 1-13, wherein the DC procedure is a conditional PSCell change (CPC) procedure.
Example 16. The method of any one of the preceding examples, wherein receiving the conditional configuration includes: receiving the conditional configuration after deactivating the SCG.
Example 17. A user equipment (UE) including processing hardware and configured to implement a method according to any one of the preceding examples.
Example 18. A method in a radio access network (RAN), communicating with a user equipment (UE) in dual connectivity (DC), for managing a conditional configuration during deactivation of a secondary cell group (SCG), the method comprising: providing, by a processing hardware of the RAN and to the UE, the conditional configuration related to a DC procedure and a condition to be satisfied before the UE applies the conditional configuration; deactivating, by the processing hardware, the SCG at a secondary node (SN) of the RAN; and releasing, by the processing hardware, at least one of the condition or at least a portion of the conditional configuration, in view of the deactivating.
Example 19. The method of example 18, wherein the releasing includes: releasing the conditional configuration.
Example 20. The method of example 19, further comprising: transmitting, by the processing hardware and to the UE, an indication instructing the UE to release the conditional configuration.
Example 21. The method of example 19 or 20, further comprising: transmitting, from a master node (MN) to a base station supporting a candidate cell associated with the conditional configuration, an indication instructing the base station to release the conditional configuration.
Example 22. The method of example 18, wherein: the releasing includes updating the conditional configuration by replacing the at least a portion of the conditional configuration with new parameters; and the method further comprises: providing, by the processing hardware, the updated conditional configuration to the UE.
Example 23. The method of example 18 or 22, wherein: the releasing includes updating the condition by replacing the condition with a new condition to be satisfied before the UE applies the conditional configuration; and the method further comprises: providing, by the processing hardware, the updated condition to the UE.
Example 24. The method of example 22 or 23, wherein: the DC procedure is a CSAC procedure; and the releasing includes releasing the at least one of the condition or the at least a portion of the conditional configuration at a master node (MN).
Example 25. The method of any one of examples 18-20 or 22-23, wherein: the DC procedure is a CPC procedure; and the releasing includes releasing the at least one of the condition or the at least a portion of the conditional configuration at the SN.
Example 26. One or more network nodes of a radio access network (RAN) including processing hardware and configured to implement a method according to any one of examples 18-25.

### ADDITIONAL CONSIDERATIONS

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters included in the MN or SN configuration described above. For example, “SN configuration” can be replaced by “SN configurations”. The SN configuration can be replaced by a cell group configuration and/or radio bearer configuration. In some implementations, “deactivating an SCG” can be replaced by “suspending an SCG” and “activating an SCG” can be replaced by “resuming an SCG,” or “reactivating an SCG.” In some implementations, “protocol layer” can be replaced by “lower layer”.

The CSAC procedure in FIGS. 5A-5E can also be called a conditional PSCell addition or change (CPAC) procedure involving an SN change. In some implementations, the CSAC procedure apply to the cases that the SN and C-SN are the same base station or different base stations.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for managing conditional configurations during SCG deactivation through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method implemented in a user equipment (UE), communicating in dual connectivity (DC) with a radio access network (RAN) via a master node (MN) and a secondary node (SN), for managing a conditional configuration during deactivation of a secondary cell group (SCG), the method comprising:
receiving, by the UE and from the RAN, the conditional configuration related to a DC procedure and a condition to be satisfied before the UE applies the conditional configuration;
deactivating the SCG at the UE;
preventing the UE from applying the conditional configuration in view of the deactivating.

2. The method of claim 1, wherein the preventing includes:
releasing the conditional configuration.

3. The method of claim 1, wherein the preventing includes:
retaining the conditional configuration;
monitoring whether the condition is satisfied;
detecting that the condition is satisfied; and
in response to the detecting, preventing the UE from applying the conditional configuration.

4. The method of claim 3, further comprising:
reactivating the SCG after the deactivating; and
in response to the reactivating, applying the conditional configuration if the UE detects that the condition is satisfied.

5. The method of claim 1, wherein the preventing includes:
retaining the conditional configuration; and
preventing the UE from monitoring whether the condition is satisfied.

6. The method of claim 5, further comprising:
reactivating the SCG after the deactivating; and
in response to the reactivating, monitoring whether the condition is satisfied.

7. The method of claim 3, wherein the method further comprises:
receiving, from the RAN, after deactivating the SCG, an indication instructing the UE to release the conditional configuration; and
releasing the conditional configuration in response to receiving the indication.

8. The method of claim 3, wherein the method further comprises:
receiving, from the RAN, at least one of a new conditional configuration related to the DC procedure or a new condition; and
replacing, at least one of the conditional configuration or the condition with the new conditional configuration or the new condition, respectively.

9. The method of claim 1, wherein the DC procedure is a conditional SN addition or change (CSAC) procedure or a conditional PSCell change (CPC) procedure.

10. A user equipment (UE) configured to communicate in dual connectivity (DC) with a radio access network (RAN) via a master node (MN) and a secondary node (SN), the UE comprising:
a transceiver; and
processing hardware configured to:
receive, from the RAN, conditional configuration related to a DC procedure and a condition to be satisfied before the UE applies the conditional configuration,
deactivate a secondary cell group (SCG) at the UE, and
prevent the UE from applying the conditional configuration in view of the deactivating.

11. A method implemented in a radio access network (RAN), communicating with a user equipment (UE) in dual connectivity (DC), for managing a conditional configuration during deactivation of a secondary cell group (SCG), the method comprising:
providing, the RAN and to the UE, the conditional configuration related to a DC procedure and a condition to be satisfied before the UE applies the conditional configuration;
deactivating the SCG at a secondary node (SN) of the RAN; and
releasing at least one of the condition or at least a portion of the conditional configuration, in view of the deactivating.

12. The method of claim 11, wherein the releasing includes:
releasing the conditional configuration.

13. The method of claim 11, wherein:
the releasing includes updating the conditional configuration by replacing the at least a portion of the conditional configuration with new parameters; and
the method further comprises:
providing the updated conditional configuration to the UE.

14. The method of claim 11, wherein:
the releasing includes updating the condition by replacing the condition with a new condition to be satisfied before the UE applies the conditional configuration; and
the method further comprises:
providing the updated condition to the UE.

15. (canceled)

16. The UE of claim 10, wherein to prevent the UE from the applying of the conditional configuration, the processing hardware is configured to:
release the conditional configuration.

17. The UE of claim 10, wherein to prevent the UE from the applying of the conditional configuration, the processing hardware is configured to:
retain the conditional configuration;
monitor whether the condition is satisfied;
detect that the condition is satisfied; and
in response to the detecting, prevent the UE from applying the conditional configuration.

18. The UE of claim 17, wherein the processing hardware is configured to:
reactivate SCG after the deactivating; and
in response to the reactivating, apply the conditional configuration if the UE detects that the condition is satisfied.

19. The UE of claim 10, wherein to prevent the UE from the applying of the conditional configuration, the processing hardware is configured to:
retain the conditional configuration; and
prevent the UE from monitoring whether the condition is satisfied.

20. The UE of claim 19, wherein the processing hardware is configured to:
reactivate SCG after the deactivating; and
in response to the reactivating, monitor whether the condition is satisfied

21. The UE of claim 17, wherein the processing hardware is further configured to:
receive, from the RAN and after deactivating the SCG, an indication instructing the UE to release the conditional configuration; and
release the conditional configuration in response to receiving the indication.
